(19) United States
(12) Patent Application Publication
(10) Pub. No.: US 2021/0383489 A1
(43) Pub. Date: Dec. 9, 2021

(54) SCHEDULING, BOOKING, AND PRICING ENGINES

(71) Applicant: SHAWN R. HUTCHINSON, HARPERS FERRY, WV (US)

(72) Inventor: SHAWN R. HUTCHINSON, HARPERS FERRY, WV (US)

(21) Appl. No.: 17/281,906

(22) PCT Filed: Aug. 16, 2019
(86) PCT No.: PCT/US19/46901

§ 371 Date: Mar. 31, 2021

Related U.S. Application Data
(60) Provisional application No. 62/719,992, filed on Aug. 20, 2018.

(51) Int. Cl. G06Q 50/14; G06Q 10/02; G06Q 10/10; G06F 16/29

(52) U.S. Cl. CPC G06Q 50/14; G06F 16/29; G06Q 10/1093; G06Q 10/025

(57) ABSTRACT

Scheduling engines, booking engines, and pricing engines with affects, interfaces, and pricing.

### CROSS-REFERENCE APPLICATIONS

This application claims priority to U.S. Provisional Applications 62/537,796 entitled ‘Value Systems,’ 62/432,528 entitled ‘A Unique Pricing Engine,’ and 62/451,520 entitled ‘Secure Authentication and Financial Attributes Services.’ And this Application is a Continuation-in-Part of PCT/US18/15,401 Application entitled ‘Secure Authentication and Financial Attributes Services,’ of PCT/US17/65,313 Application entitled ‘A Unique Pricing Engine,’ and of PCT Application entitled Value Systems' filed on Jul. 27, 2017. The entire contents of these applications are hereby incorporated by reference.

### FIELD OF INVENTION

Scheduling, booking, pricing, payments, affect, interfaces, connections, communication, and networks are the fields of endeavor for the invention.

### BACKGROUND

Attributes that pertain to events and activities are increasingly relevant for the purposes of scheduling and booking. Identifying and matching these attributes with those of a personal interest are complex, especially when attributive and affective factors are often unspecified or unknown. These factors pertain to people, as well as activities and events, and the levels of complexity increase exponentially when identifying scheduling options. Such factors exist on sides of supply and demand, and can be specific to activities and events, whose availabilities and relevance are also subject to unpredictable factors such as attitudes, traffic, and weather.

With the simultaneous increase in complexity of factors, as well as options for events and activities, there clearly exists a need to develop efficient and effective ways of scheduling. Moreover, the ease of presenting and selecting options for scheduling and booking increases the time available for participating in activities and events. This process is known in the instant application as scheduling and booking engines to include the preparing, presenting, and selection of options for scheduling and ways to book. In addition to ease, simplicity is also needed for the purpose of making the interfaces and interactions with the engines productive.

Further, numerous ways of generating customized pricing exist in the marketplace. However, there lacks a method of providing unique pricing for products and services according to the customer. Customized pricing, however, seeks to provide tailored prices for customers according to strategies that are determined by inventory, bulk discounts, supply chain costs, pricing plans, class plans, category plans, pricing tables, and coupons. Such prices may be referred to as customized, personalized, tailored, optimized, intelligent, group, sales, markup, markdown, adjusted, discounted, dynamic, and/or prioritized pricing. In contrast, unique pricing provide prices for products and services that are unique to the customer.

Moreover, authentication and financial services systems often rely on application to propound information in a manner that is useful for verifying identity and obtaining financial services. Personal identity data is provided by a consumer on a loan, for example, and the information is inputted into a database. The data is checked and processed, and yet consumer records are held within a business database. The identity information often includes private data such as a social security number that may be encrypted or not, and transmitted in other transactions or internal to an organization. Such data, is an essential identifying feature for a consumer, and yet also vulnerable because it is a number that is assigned to a person for the duration of a lifetime. Therefore a practice and service that allows a consumer to obtain improved authentication and financial transactions advantageously protects businesses and consumers.

Additional transactions encompass the transmission of private data that pertains to a consumer that is not otherwise public information. Credit card numbers, as another example, are often held in business systems in order to process transactions on behalf of the customer. A business that records credit card numbers results in costly expenditures to businesses for the security and protection of consumer information. Furthermore, the cost of indemnifying and discovering fraudulent credit activity is an expensive cost to credit card companies. Therefore a practice and service that allows businesses to transact financial services such as credit card transactions without the exposure of credit card numbers advantageously protects credit card companies, businesses that depend on credit, as well as consumers.

The inventions and embodiments described herein pertain to methods of preparing and articles/interfaces that are prepared by one or more scheduling, booking, and pricing engines.

### SUMMARY

A vitally-important aspect for schedules is coordinating availability, supply, and demand of services and/or goods. The preferred embodiments described herein refer to approaches that generate bookable interfaces and schedules for people, places, and businesses. This includes rules of demand scheduling that are determined according to relations of one or more individual or group interests and availabilities. Rules and relations of demand scheduling appertain to availability and logistical details such as time of day, proximity, location, cost, and duration. Rule and relations also pertain to human factors of those who are involved in a schedule including, for example, affect, interest, history, physical ability, age, compatibility, interpersonal cooperation, individual disposition, and wellbeing.

Rules and relations furthermore appertain to factors that are associated with the activity or event, such as reputation, rating, type of physical activity, amount of physical activity, difficulty level, strenuousness, ease, relaxation, luxury, sunlight exposure, enjoyment, and aspects that gauge the affective or attributive interest of one or more participants and other people have for the activity or event including for example like, dislike, love, joy, thrill, fulfilling, adventure, and happy. Factors also are directed towards existing service industries, industrial sectors, process steps, software, and manufacturing usages include one or more of and not limited to metrics, productivity, number of bookings, earnings from bookings, ratings, reviews, usage of resources, efficiency, optimization, dynamic environments, adaptation, fuzzy logic, data inferences, statistical methods, probability, likelihood, stochastic analyses, parameter modeling, data mining, database processing, reports, quality, on-demand pricing, product standards, security, privacy, and encryption. Scheduling engines also include rules and relations that pertain to restrictions, equipment, limitations, waivers, and insurance requirements. Scheduling engines therefore seek to ascertain schedules of activities and events that one or more individuals wants to participate in, and may include approaches to schedule, book, confirm, waitlist, cancel, modify booking, rebook, reschedule, reconfirm, and pay for activities, tickets, and events.

Furthermore, scheduling pertains to supply as an entity such as persons and businesses that offer activities and events for scheduling or booking. The entity sets and updates rules and relations that pertain to availability and logistic details as well as rules that pertain to human factors and factors that are associated with the activity or event. Approaches to facilitate generation of bookings and scheduling include ways of communicating with one or more individual or groups, including, for example, one or more of sms text message interactions, voice interactions, algorithms, application interactions, graphical interfaces, electronic interpretations, responses, settings, history, surveys, feedback, behavior, bots, and human intermediaries. Additionally, supply scheduling includes rules and relations that pertain to cost, pricing, earnings, acceptability, booking settings, payments, credits, thresholds, bidding, pricing, incentives, futures, accounts, and rewards. Scheduling also includes goods and services related to activities and events. Schedules pertain to human activities and events and schedules for goods and services that humans purchase or book. Rules and relations are configured and implemented to schedule demand, requests, and bookings for activities, events, goods, and services. Rules and relations are configured and implemented in order to schedule and book one or more activities, events, listings, and services. Rules and relations are also configured and implemented to purchase and supply one or more products, goods, and resources.

### FIGURES

FIG. 1. An Interface comprising a booking button with display and features.

FIG. 2. An Action Interface as a booking button with display and features.

FIG. 3. An Action Interface as a buying button with display and features.

FIGS. 4A-4E. Interfaces and Action Interfaces having combinations of features and displays.

FIG. 5. An Action Interface with actions, advertisement, command, displays, and features.

FIG. 6. An Action Interface with actions, commands, display, features, and search engine.

FIG. 7. An Action Interface with advertisement, commands, display, features, voice-activated interface, and swipe action interface.

FIG. 8. An Interface comprising an action, button, display, features, and type interface.

FIG. 9. An Interface comprising actions, advertisement, commands, display, and features.

FIG. 10. An Action Interface comprising a command, display, and features.

FIG. 11. An Action Interface comprising actions, commands, display, and features.

FIG. 12. An Interface comprising actions, commands, display, and features.

FIG. 13. An Interface comprising actions, commands, displays, and features.

FIG. 14. An Interface comprising actions, advertisements, commands, displays, and features.

FIG. 15. An Interface comprising an action interface, actions, commands, displays, and features.

FIG. 16. An Interface comprising action interfaces, actions, commands, displays, and features.

FIG. 17. An Interface comprising an action interface, action, command, display, and features.

FIG. 18. An Interface comprising actions, commands, displays, and features.

FIG. 19. An Interface comprising actions, commands, displays, and features.

FIG. 20. An Interface comprising actions, commands, displays, features, and action interfaces.

FIG. 21. An Interface comprising actions, commands, displays, features, and action interfaces.

FIG. 22. An Interface comprising actions, commands, displays, features, and action interfaces.

FIG. 23. An Interface comprising an action, displays, and features. Elevations furthermore show embodied thicknesses of the device interface.

FIG. 24. An Interface comprising an action, commands, displays, and features. Elevations furthermore show embodied thicknesses of the device interface.

FIG. 25. An Interface comprising an action, commands, displays, features, and action interface. Elevations furthermore show embodied thicknesses of the digital interface.

FIG. 26. An Action Interface comprising an commands, displays, and features. Elevations furthermore show embodied thicknesses of the device interface.

FIG. 27. An Action Interface comprising an commands, displays, and features. Elevations furthermore show embodied thicknesses of the digital interface.

FIG. 28. An Interface comprising engine actions, commands, displays, features, and an action interface.

FIG. 29. An Interface comprising engine actions, engine commands, displays, features, and an action interface.

FIG. 30. An Schedule Interface comprising features from a pricing engine.

FIG. 31. An Purchase Interface comprising features from a pricing engine.

FIG. 32. A flow diagram of processes within scheduling, booking, and pricing engines.

### DEFINITIONS

A Schedule includes one or more of a booking or one or more records for search results, an appointment, calendar, reservation, itinerary, plan, a statement, strategy, form, agenda, electronic method, diary, journal, timetable, timeline, list, listing, stock, class, market listing, exchange, marketplace, batch, clearinghouse, debits, credits, arrangement, table, seat, chair, resource, room, computer, device, clearinghouse, automated clearinghouse, spreadsheet, steps of a process, a reaction pathway, contingencies, procedure, a traversal, a sequence, arrival chart, departure chart, worksheet, transportation route, delivery list, waitlist, seating, tax, rate, tariff, materials, intermediaries, inventory, and one or more aggregates and derivatives thereof.

A Person includes a human being doing an action on behalf of oneself as well as on behalf of others. For example, a person could be a conveyor of an automobile, and a person could be a child, guardian, parent, dispatch, or responder. A person includes any involvement of a human with any portion of a scheduling or booking activity, event, or operation. Person furthermore includes human beings that interact through Programming interfaces, graphical interfaces, texting, telephonic calls, emails, or any multimedia communication. Person may also include substitutes for humans including for example one or more of a corporation, business, company, entity, department, government, or agency. A person is an active agent in bodily or material form. A person may also include human personifications, in whole or part, such as in voice, interface, in body, including animations, graphical representations, creatures, mammals, avatars, or artificial intelligences. A person also encompasses a group or collection of persons.

An Electronic includes one or more of a method, an executable, software, an Application, an Application Programming Interface (API), artificial intelligence, graphical interlace, a robot, a bot, a druid, a drone, and combinations thereof. An electronic method includes one or more of an algorithm, device, procedure, process, protocol, bit sequence, quantum bit sequence, executable code, process, instructions, strategy, circuit, cipher, contract, transaction, transfer, credit of any allotment, time, or monetary resource, debit of any allotment, time, or monetary resource, ledger, encryption, blockchain, memory, data storage, transformation of data, stream, feed, interpretation of data, sequence, media, light pattern, medium, batch, script, and device.

Action is any area that responds to input received from a person or electronic in one or more of and is not limited to an acknowledgement, arrival, confirmation, check-in, departure, navigation, response, rsvp, book, buy, click, consent, checkable, haptic input, a mark, imprint, embossment, affirmation, flourish, signature, initials, yes, no, possibility, maybe, aye, nay, or relayed transaction with an intermediary as a person or electronic. An action may be a process, a routine, function, feature, or script. An action may be, call, or generate one or more of and not limited to a calculator, schedule checker, scheduling conflict resolver, scheduling engine, booking engine, harmonizer, scheduler, sorter, payment, payment processor, a pricing engine, authentication, verification, code, script, permissions, procedure, protocol, APIs, and combinations thereof.

An Action Interface comprises an action and a command. An action interface may request, retrieve, process, forward, respond, and combinations thereof to a person or electronic. An action interface may comprise a booking interface, buy interface, purchase interface, such as a button or cart, and one or more buttons. An action interface may display as, function as, and be in entirety, a clickable area or actionable button. An action interface may establish or make one or more connections.

Action Interface, action, actionable item, may include one or more of and is not limited to a button, single cock, double-click, long click, pattern, any navigation button or clickable area, next button or clickable area, a previous button or clickable area, a clickable hyperlink, a pause button or clickable area, a play button or clickable area, a stop button or clickable area, a skip/next backward button or clickable area, a skip/next forward button or clickable area, a forward button or clickable area or button, a rewind button or clickable area or button, an information area or button, a stop area or button, a cancel area or button, a question area or button, a polymorphic area or button, hide, grey-out, conceal, add, delete, subtract, subtend, protract, expand, zoom, highlight, pinpoint, and combinations thereof.

An Action Interface, action, actionable item may comprise one or more of and not limited to a command, connection, eye response, click, text box, text box, search field, responsive prompt, responsive area, light, light pattern, button, navigation, interaction, interface, GUI, any widget, and combinations thereof. Actions may be presented in one or more of and not limited to a display, type, visual, and combinations. Actions may be responsive to one or more of and not limited to a commands. Actions may include one or more and not limited to being responsive, retrieve, present, schedule, revise a schedule, book, purchase, buy, and combinations thereof.

Advertisement, advert, ad, is one or more of and not limited to an affect, destination, type, device, visual, display, feature, interface, action interface, portions thereof, and combinations thereof. An advertisement may include one or more of any price, unique price, cost, and payment.

Affect is an emotion, feeling, intuition, sense, sentiment, or state of being. Examples include like, love, pleasure, enjoy, desire, relax, restful, want, content, satisfy, or dislike. Affects may assign a value to an action, thing, activity, event, person, or electronic. A person or electronic may assign an attribute, state, value, meaning, topic, interest, or rule. And in combination affects may generate or define additional rules, relations, features, interfaces, action interfaces, payments, costs, bookings, appointments, calendars, schedules, electronics, persons, and combinations thereof. and they may be specific to an individual, couple, family, aggregate, group, or population of peoples. One or more affects may be assigned to a particular instances of an appointment, activity, event, service, or good for a person or electronic to assign, assess, relate, store, analyze, label, or affix, either temporarily, transiently, or permanently, a value, meaning, quality, quantity, and any combinations thereof.

Affects may be inputted, expressed, or obtained through person-to-electronic interactions, interfaces, correspondence, reviews, digests, traversals, iterations, and surveys, as well as electronic-to-person, person-to-person, and electronic-to-electronic variations thereof. Affects may comprise rules and relations in order to determine workable, compatible, or appropriate bookable instance, schedules, itineraries, or complementarity. A combination of affects may estimate, forecast, project, determine, or interpolate an action or response.

Affects may be quantified, qualified, and combinations thereof. An affect may be quantified with superlatives, ratings, rankings, emojis, surveys, statistics, numerical methods, and combinations thereof. Affects may be qualified by emojis, rules that define affects, and relations among and between affects. Rules and relations of affects may be found in the works incorporated herein by reference. Affects furthermore include and are not limited to expression forms that may be include input, display, or responds with one or more emojis, haptics, interfaces, action interfaces, texts, typing, audibles, visuals, and combinations thereof.

Alert is an alarm or notification sent by a person or electronic to a person or electronic as one or more of an action, action interface, connection, audible, visual, text, traversal, and sequence, and combinations thereof.

Audible includes and is not limited to one or more of an auricular, audible, voice, heard, tonal, frequency, music, midi, an audible sound, a gestured sound such as “uh-huh,” “hmph,” “yeah,” and “mmm.” An audible may comprise a command such as for example “book”, “help”, “now”, “next available,” “pay.” An audible may comprise any command known to navigate a search engine, select search results, book an appointment, pay at a checkout, and pay for a purchase. An audible is generated by a person, a electronic, or combinations thereof.

Availability is a time or resource may be searched, booked, and/or scheduled.

Bookable is an interaction wherein a person or electronic can reserve time. A bookable interaction is one that may include an interface, action interface, a display, a payment, a confirmation, and combinations thereof. A bookable interactions may be generated by a electronic for booking by a person or electronic. A bookable interaction may be generated by a person or electronic according to rules, relations, and combinations thereof.

Booking is one or more of a record in a schedule, an engagement of time, a reservation in daytime, a nightly reservation, an interface that schedules time, confirms an appointment, an entry into a schedule, and a record of an appointments for an activity, event, good, service, ticket by a person or electronic.

Cost includes one or more of and is not limited to a price, a unique price, an I.O.U., estimate, quote, discount, debit, lien, credit, value, swap, call, put, option, index, future, fund, bid, hedge, allotment, size of text, number of texts, plan, minutes, and measures of time. A cost is an amount payable in currency, monetary form, cryptocurrency, index, swap, derivative, fund, time, or any type, form format, portion, or whole of valuation, and any combinations thereof.

Commands include instructions for performing actions or navigating through interfaces, payments, searching, scheduling, and booking. Commands include, for example, “go to,” “find,” “get next available,” “add person,” “check please,” “book that,” “click that,” and “pay now.” Commands are one or more of and not limited to prompt, response, click, eye movement, static indicator, stasis, dynamic, pattern, light, flash, cycle, frequency, movement, swipe, slide, shake, gyroscope, tap, touch, track, alert, notification, search, schedule, book, payment, and combinations thereof. Commands may be events generated by one or more of and not limited eyes, eyeballs, nose, nostril, hair, clothing, fabric, ears, mouth, fingers, feet, body, touch, weight, height, size, color, sound, smell, feel, taste, look, gesture, sign, language, phrase, letters, password, code, alphanumeric type, barcode, QR code, cipher, biometric, animal, pet, smart phone, and combinations thereof. Commands may include one or more of and is not limited to the usage of pronouns, adjectives, verbs, adverbs, phrases, slang, verbal phrases, parts of speech, and proper names for one or more and not limited to a person, software, electronic, trademark, copyright, title, online data, electronic device, domain, website, payment device, credit card, searches, responses, retrievals, traversals, and combinations thereof.

Commands also include natural language commands that are used in common language as well as verbalized cues for interfaces between a person and a electronic as well as between one person and a second person that pertain to, for example, one or mare of and not limited to appointments, bookings, reservations, scheduling, and combinations thereof. Combinations of dates, times, calendars, identification, indicia, cost, and payment information may be used in combination with commands. For example, a command is “book,” “buy,” “book Tuesday at 2” or “find Jane Doe's calendar,” “book this appointment,” and, i.e., “click” or “pay now.” Commands generate actions in an interface or instructions on behalf of a person or electronic including one or more of and not limited to a connection, type, interface, display, and combinations thereof.

Connection is a mode of communicating among people and electronics. Connections include, for example, one or more of and not limited to any content feed, live feed, addressed addressables, broadcast feed, television feed, radio broadcast, narrowcast, distributed feed, syndicated feed, telephone call, mobile call, text, electronic message, email, sms message, relay, text, page, audiovideo file, recording, hologram, virtual reality visual, action interface, interactive display, electronic interfaces, address, data, ledger, memory, and storage.

Destination is a location for a person or a electronic. A destination for a person may be one or more of and not limited to a physical location, place of business, proximity, geographic coordinate, automobile, venue, sporting event, gathering, store, market, conference, vehicle, airplane, train, mode of conveyance, a city, country, nation, continent, park, hotel, lodging, house, locker, restaurant, resting place, and combinations thereof. A destination for a electronic may be one or more of and not limited to a beacon, a cookie, a tracking device, a log, a record, a storage device, delivery of data to a person, an audio feed, a video, movie, an advertisement, a position in memory, interface, engine, interface, action interface, API, port, input, output, device, IP address, MAC address, serial number, barcode, QR code, plus code, encryption electronic, cipher, hash, location, location-marker icon, an icon, mark, marking, map, GPS position, coordinates, pipeline, batch, script, function, address, physical address, attribute address, software address, account, clearinghouse, and combinations thereof.

Device is an input/output (i/o) equipment, machinery, or electronic. Devices may comprise one or more of and not limited to an electronic device, screen, badge, card, haptic interface, memory, storage, database, database table, page, a clearinghouse, a camera, a light, keyboard, mouse, mousepad, fingerpad, tracking device, beacon, homing device, a remote control, television, radio, electronic, smartphone, IPHONE, tablet, desktop computer, IPAD, IPOD, music player, circuit, a printer, an additive manufacturing printer, be printed, generate electricity, robot, artificial intelligence, virtual machine, cloud, network, internet browser, a visual overlay on an internet browser, an advertisement network, virtual window, electronic window, physical window, kiosk, interactive display, digital signage, any plug-and-play electronic, comprise at least one port, accessible through a serial bus, have an antenna, be invisible, be a facsimile, be rendered, utilize a circuit, utilize an electronic circuit, utilize an electric circuit, utilize a bit, utilize a byte, utilize a qubit, utilize an electron, utilize software, portions thereof, and combinations thereof. A device is of desired size, shape, material, thickness, and weight. A device comprises a screen that may be 3.37 inches×2.125 inches, proportional by ratio, and any desired size. A device has a thickness of 1 mil or less and up to 1 cm, 1 inch, or more.

Display is is one or more of an article, an apparatus, or device that presents one or more of and not limited to an audiovisual, audio, byte, bit, string, visual, illustration, video, movie, vignette, storyboard, camera, graphic, overlay, interlace, frame, mesh, stream, image, rotation, electronic storefront, print, audible, auricular, voice, swipe, holographic forms, and combinations thereof. A display may comprise one or more of and is also not limited an advertisement, alarm, alert, light, sound, event, feature, interface, notification, price, button, interface, action interface, and combinations thereof. A display may be a size of intent, expandable, contractible, scalable, dynamic, rendered, active, touchscreen, passive, full-screen, wrap-screen, hologram, holograph, a frame, table, widget, and any portion thereof. A display may be one or more of and is not limited to any shape, design, color, configuration, electronic, film, flexible, water-proof, wind-proof, dust-proof, surface, depth, dimension, tile, projection, material, pixel, assemblage, mosaic, visibility, invisibility, conceal, actionable, retractable, protractible, mechanical, electronic, olfactory, tactile, haptic, portions thereof, and combinations thereof. A display may range from one pixel to one meter square, linear, geometric, color, or polar space. A display may be 3.37 inches×2.125 inches, proportional by ratio, and any desired size. A display may comprise a device with a thickness of 1 mil or less and up to 1 cm, 1 inch, or more.

Engine is a device, electronic, or machine for receiving inputs and producing outputs. Inputs may be received such as for example from a person, from an electronic, through electronic transmissions, via devices, wired connections, wirelessly, over networks, and combinations thereof. Outputs may be sent to a person, to an electronic, through electronic transmissions, via devices, wired connections, wirelessly, over networks, and combinations thereof. The engine receives inputs such as affects, requests, responses, retrievals, transmissions, notifications, data, records, rules, relations, actions, and alerts, for example. The engine produce, generates, or send outputs, for example, such as responses, data, displays, records, relations, rules, actions, and action interfaces. The engine produces outputs from the inputs according to one or more of logic, relations, rules, algorithms, scheduling processes, payment processes, pricing processes, booking processes, usage of APIs, circuits, software, and combinations thereof. Examples of engines are an advertising engine, booking engine, scheduling engine, pricing engine, payment engine. One or more engines may be used in combination and any combination of sequence and/or simultaneous steps of input and output.

Engines may implement logic according to algorithms, methods, processes, procedures, and steps that pertain to the field of use. Engines may include triggers, query language, traversal, sort, indexer, digest, find, hash, locate, authenticate, verify, scheduled events, structured query languages, object-oriented programming, batches, scripts, blockchain ledger, a markup language, and combinations thereof. Engines may generate one or more actions, action interfaces, commands, displays, events, features, and combinations thereof. Engines may implement one or more approaches to logic as sources in the instant Specification, as diagrammed in the instant and cross-referenced Figures, in references incorporated by reference, and combinations thereof. Logic may be explicated from these sources by narrating in written or spoken language the logic as shown. The sources are incorporated by reference and may be used as specification for the purposes of setting forth patentable claims, limitations, and amendments. Sources for engines including the input and output may also include existing rules and relations from one or more websites that pertain to appointments, booking, scheduling, payments, and pricing. The websites in the source section provide examples of such engines that are incorporated by reference in their entirety and may be used as specification for the purposes of setting forth patentable claims, limitations, and amendments.

Engines may furthermore utilize associations, conditionals, equalities, equivalents, inequalities, statements, formal logic, and informal logic from, for example, statistical methods, inferences, induction, adduction, extrapolation, interpolation, machine learning, neural networks, APIs, and combinations thereof in order to determine one or more outputs from one or more inputs. For example, a scheduling engine may comprise statistical machine learning according to affects that are ascertained through processing text input and customer feedback. The scheduling, booking, payment, affect, and handler engines utilize the statistical associations between activities, affects, and ratings in order to generate booking features, action interfaces, displays, and unique prices according to a person's affect history, interests, and profile.

An engine may link data or records. A link is a URL, an association, pointer, reference, data structure, map, state, phase, mapped correspondence, mapped association, cipher map, mapping procedure, hashmap, graph, directed graph, neural network, state, phase, machine learning that corresponds one or more of a first data or record with one or more of a second data or record, and combinations thereof. A handling engine manages among and between one or more engines, such as for example a scheduling-, booking-, payment-, and affect-engine, one or more of and not limited to methods, calls, communications, connections, sequences, simultaneous steps, processes, calls, APIs, transmissions, receipts, requests, responses, and combinations thereof. Handlers may also manage such activities among and between two or more scheduling engines, booking engines, payment engines, and affect engines. Handlers may also manage such activities among and between two or more people, devices, electronics, groups, persons, engines, servers, software, programs, actions, action interfaces, commands, displays, interfaces, features, records, memories, databases, and combinations thereof.

Event is a thing to do or done by a person or electronic that may be one or more of and not limited planned, scheduled, unplanned, impromptu, in situ, API call, alarm, alert, notification, request, retrieval, response, spontaneous, on-demand, batch, script, and combinations thereof.

Feature includes one or more of and is not limited to a name, image, photograph, video, voice file, indicia, text, review, price, hyperlink, song, tune, snippet, reference, hash, hashtag, tag, encryption, or pointer. A feature may be included on, or in, one or more of a frame, table, display, a thumbnail, an icon, stand-alone, text, sms, API call. VoIP, voice call, function, script, electronic, a device, an action interface, interface, portions thereof, and combinations thereof.

Interface is one or more of and is not limited to display or presentation forms in visual, auricular, audible, spoken, clickable button, haptic, text, holographic, material, physical, printed, QR code, barcode, any representation that is linkable to an action interface, input, bus, or any representation that in actionable, responsive, or linkable to a person or electronic. An interface comprises an area of 3.37 inches×2.125 inches, proportional ratio, or any desired size. An Interface is a representation of one or more actions, commands, displays, features, actions interfaces, rules, and relations of one or more schedule, booking, pricing, and payment engines.

An interface comprises for example an area of 3.37 inches in length×2.125 inches in height×0.37 inches depth, which may comprise a device. An interface area may be an area of 3.37 inches in length×2.125 inches×0.05 inches and display on an electronic screen. An interface area may be 2 inches in length×1 inches in height×0.37 inches depth, which may comprise a device and be used for example as a keychain. Interfaces may include all or portions of any device size. Thicknesses may be 0.05 inches, 0.25 inches, 0.5 inches, 0.75 inches, 1 inch, 1.25 inches, 1.5 inch, 1.75 inches, 2 inches, or more, and combinations thereof.

Further display, device, and interface sizes include one or more of and combinations of: http:/screensiz.es, https://www.rtings.com/tv/reviews/by-size/size-to-distance-relationship, https://en.wikipedia.org/wiki/Display_size, which are herein incorporated by reference. Dimensions may be extrapolated, protracted, and interpolated according to desired shapes, sizes, display distances, and aspect ratios. Displays, interfaces, and devices may furthermore comprise any of kiosk display sizes, jumbo displays sizes, and advertisement display sizes. A display, device, or interface may furthermore have no display, screen, or interface size. One or more portion, part, or whole of an display, device, or interface may be without a visible display, screen, or interface. One or more portion, part, or whole of an display, device, or interface may be comprise an display, screen, or interface that is navigated by for example one or more of an electronic, another device, a robot, a bot, processor, circuit, gesture, sign, action, command, audible, frequency, light, and combinations thereof.

Further, a device may have a border around, a display. This border may be a perimeter or portion of a perimeter on at least a portion of a side, corner, edge, periphery, bevel, nose, bead, trim, case, handle, and piece. A border between the outer edge of a display and an outer edge of a device may be 0.1 inch or less, 0.2 inch, 0.3 inch, 0.4 inch, 0.5 inch, 0.6 inch, 0.7 inch, 0.8 inch, 0.9 inch, 1 inch or more. All dimensions may instead substitute centimeter for inch. Action interface and interface sizes may be in whole, part, selected, varied, proportional, and combinations thereof for any embodiments herein.

Method includes one or more and not limited to steps, processes, intermediaries, business methods, executables, computational implementation, and combinations thereof. A method may be implemented with one or more of and not limited to a microprocessor, processor, circuit, integrated circuit, memory, program, device, software, batch, and script.

Multi-valent response comprises data that signifies one or more modes of information, such as a decision and a confirmation number. Modes of information include gradients, scales, litmus, advisory, alert, caution, signs, symbols, signals, colors, wavelengths, frequencies, and any manner of encoding information. One or more types or forms of data may accompany, associate, follow, precede, refer to, sequence, and/or transmit with one or more modes of communication within any duration or span of time.

Haptic includes one or more of and are is limited to input to a electronic or device using tactile, mechanical, or physical responses. Haptic includes and are not limited to one or more in of texture, vibration, olfactory, braille, physical patterns, physical buttons, squeeze, tilt, shake, taps, slides, swipes, zooms, sequences thereof, patterns thereof, and combinations thereof.

Language includes and is not limited to one or more of a spoken language, a written language, a electronic coding language, a scripted language, semantic relations of symbols, a relation among rules, a traversal of data, a sequence of relations, and combinations thereof.

Name include one or more of and is not limited to the usage of pronouns, adjectives, verbs, adverbs, phrases, slang, verbal phrases, parts of speech, and proper names for one or more and not limited to a person, location, place, business, service, product, good, venue, arena, theater, show, software, electronic, trademark, copyright, title, online data, electronic device, domain, website, payment device, credit card, searches, responses, retrievals, traversals, and combinations thereof. Names may be used as one or more command.

Payment is one or more of and is not limited to currency, monetary device, co-pay, financial instrument, stock, bond, exchange, mutual fund, cryptocurrency, coins, derivatives, notes, futures, and may also be or include an appointment, availability, booking, commitment, conditional, confirmation, value, electronic method, resource, schedule, time, and combinations thereof.

Payment device is one or more of and is not limited to a point of purchase device, a checkout, a cart, payment interface, credit card, debit card, payment card, chipcard, magnetic stripe device, gift card, gift balance, allowance, an exchange, radio frequency device, radio frequency identifier, rfid, QR code, barcode, serial number, number, alphanumeric string, automated clearinghouse, a cryptocurrency exchange, cheque, account, release, wire, transfer, ACH bank transfer, account, App, transfer, sim card, microchip, and combinations thereof.

Profile is a personal account displayable by any electronic or on a device. The profile may be a data structure that contains data such as an alphanumeric identification string for a person, electronic, booking, schedule, payment, record, or device. A profile may provide access to one or more accounts each of which are managed by one or more persons or electronics. Examples of accounts are banking, financial, services, membership, and subscriptions. Profiles may generate or provide access to one or more engines engines and generate displays of unique prices, financial services, pricing, bookings, schedules, payments, and displaying data. Any action, action interface, command, event, display, feature, and combinations thereof, may be accessible by an engine so as to effectuate actions according to one or more affect, data, and/or records in any desired sequence, series, simultaneity, and combinations thereof.

Profiles provide ways to refer to records that pertain to one or more person, electronic, schedule, booking, payment, price, and combinations thereof. Profiles may be accessed, queried, and sent transmissions according to device addresses, attribute addresses, location address, email address, and combinations thereof. One or more addresses may be indexed and addressable with or without knowing the identity of a person or electronic associated with a profile or alphanumeric identifier. A profile may comprise attribute addresses that are accessible without an identification number of a person. A profile may comprise an identification number, cipher, reference code, distinct alphanumeric string, ledger, or unique alphanumeric identifier.

Polymorphic Action is an action whose display changes one or more audio, visual, action, command, type, and combinations thereof. The polymorphic action includes a sequence, series, and simultaneous effects on a display. The polymorphic action may be used to consolidate visual space, for example, while also providing convenient views of features, data, records, representations, and designs. The polymorphic action may change color, size, shape, emoji, affect display, icon, image, hue, saturation, tint, shading, animation, sticker, overlay, animated visual effect, graphical effect, play a tune, font variations, text rendering, glyphs, a video, vignette, snippet, sparkle, render, grey-out, morphs, maps, and combinations thereof. Polymorphic actions may also, or instead, vary in effect with visual effects as are in a markup or script language such as HTML, HTML-CSS, XML, Javascript as well as any effect be effectuated for a polymorphic action including Adobe Creative Cloud. Adobe Creative Cloud software includes for example and is not limited to Photoshop, Illustrator, InDesign, XD, Premiere Pro, After Effects, Dimension, Lightroom, Spark, Behance, Dreamweaver, Animator, Character Animator, Audition, Prelude, and Fuse. These are incorporate by reference here and in the corresponding reference section of the instant Specification.

Polymorphic actions may call one or more APIs or SDKs for example in order to display a sequences of actions, commands, input for an engine, output for an engine, events, displays, features, and combinations thereof. A polymorphic action may be an action interface responsive to an action of one or more of swipe-up, a swipe-down, swipe-right, swipe-left, swipe-diagonals up, swipe-diagonals down, swipe geometric shape, sign, signed finger, and hand gesture to display a new record such as a month, week, time of day, person, event, and activity. Polymorphic actions may be a button. Polymorphic actions may comprise any one or more of and not limited to representation: affect representation, action representation, alert representation, audio-visual representation, connectivity representation, currency representation, numerical representation, record representation, review representation, symbolic representation, sequenced interfaces, scheduled interfaces, and booking interfaces.

Receiving is gathers input or provides a communication port for input of data.

Record is for example and not limited to an account, data, data structure, log, memory, table, storage, file, history, or ticket about a person, place, activity, and combinations thereof. Records may be for example and not limited to analyzed, aggregated, transformed, interpreted, translated, pivoted, inferred, have operations performed upon, have functions performed upon, have statistics performed upon, and combinations thereof. Records may be for example static, dynamic, encrypted, encoded, transient, indeterminate, hidden, referenced, pointed to, contracts, ledgers, crypto-ledgers, smart contracts, and combinations thereof. Records comprise data that has actions performed such as for example and not limited to being set, a setting, revised, added, deleted, removed, stored, and according to computer science, computer languages, computer scripts, computer markup languages, and combinations thereof. Further examples of how records and data are constituted may be found for example in A Computer Science Tapestry, herein incorporated by reference in its entirety. Further sources are explicitly reference to the sources section which comprises further explication of actions for records.

Relations define one or more attribute, category, characteristic, property, value, and state of features. Relations may be also be predetermined according to settings of an engine that define the process of generating the output according to one or more inputs. Relations may be used to determine how to generate or produce actions, action interfaces, commands, displays, interfaces, and combinations thereof, in whole or part. Relations may be defined by one or more conditions, settings, profile, registration, account functionality, and account permissions. Relations may also be defined by regulations that govern industries and consumer protections.

Relations may also pertain to how engines produce output, features, action interfaces, commands, displays, and interfaces. Relations may be determine associated factors that effectuate the scheduling or booking of an activity or event, for example. For example, relations for bookings may pertain to booking availability, price offsets, quickest pathway to a destination, scheduling compatibility, and pricing calculations. Relations provide the means by which decisions are made and are determined in part by the rules, inputs, settings, and features that are utilized to define them. Persons, electronics, users, profiles, actions, commands, interfaces, displays, APIs, calls, responses, retrievals, and transmissions may for example define relations.

Relations may furthermore be defined according to genus-species attribute, category, characteristic, property, value, and state of a thing of a record, data, action, interface, command, booking, display, and feature. In addition, relations may be defined by a Linnaean classification system to include one or more of kingdom, phylum, class, order, family, genus, and species.

Further, relations may pertain to classification methods that encompass one or more associations, causations, categories, hierarchies, regularity, stratifications, type, and combinations thereof. Relations may follow indeterminate, statistical, or subjective type classification. Relations may be defined according to an API or Software Development Kit (SDK) that determines the activity, features, and functionality of one or more actions, affects, commands, devices, electronics, features, and interfaces. Relations may furthermore be ascertained according to statistical, empirical, and computational methods. Empirical methods include the relations defined in disclosures that are incorporated herein by reference.

As an exemplary case, relations among affects are determined by their relations as defined in citations incorporated by reference. Relations among affects may furthermore be ascertained through user input that provides the data needed for a statistical traversal to ascertain relations among affects that are specific for people. A statistical, machine-learning method may determine an affect of “love” for one person may have a relation to a sense of relaxing for an activity while for another an affect of “love” for another person may have a relation to a sense of strenuous for the same activity depending on the level of a person's physical fitness. While relaxing and strenuous are both related to the affect of love, there are two types of persons. Relaxing and strenuous are different types in that one is static and another dynamic. Affects are for example defined according to an affect that a person utilizes to describe a sense about an activity, event, time, place, and, another person.

Determining these relations among affects for example may be obtained through for example user input, feedback, questionnaires, machine learning, interpreting, and reviews. Compatibility among affects utilized by a person to describe an activity are among determining relations that a scheduling engine may utilize to determine whether participation in an event by one or more persons is for example schedulable, bookable, or to determine a price. Relations determine how an engine produces outputs. Relations according to affects and attributes may be utilized by an engine to determine to unique pricing or addressed pricing for a person.

Relations may be utilized as inputs for an engine to at least in part determine an output of one or more actions, commands, displays, electronics, features, interfaces, prices, schedules, and values. Specific types of relations among particulars may be organized in a memory as a database, library, or storage data pertaining to one or more of and not limited to statistical interpretation, forecasting, extrapolation, prediction, interpolation, inferences, and machine learning about data. These methods may be utilized or accessed by an engine, and may also be instantiated for one or more of and not limited to an activity, event, person, review, and rule. Relations are in part determinable by inputs and features that constitute data. Whereas rules determine for example time, distance, location, price, and quantity, relations determine attribute, category, characteristic, property, quality, value, and state. Relations distinguish the specifics of one type of thing from another thing of the same type.

Registering is a way of inputting data into one or more of and not limited to a record, data structure, profile, and combinations thereof. Registering my occur through for example one or mare of and not limited to an action interfaces, interfaces, commands, electronics, devices, displays, records, profiles, and combinations thereof. Registering may be done for example by one or more of a person, electronic, and combinations thereof.

Register is a point of purchase electronic or device used to check-out purchases of goods and services. A register may be for example in a store, kiosk, online, in a marketplace, a cart, and combinations thereof. A register may include a barcode scanner. A register may be an electronic on a device such as a mobile App that tracks products and purchase history.

### Representations

Representations in one or more of the embodiments and figures include actions, commands, display, features, interfaces, and action interfaces. Representations may comprise one or more polymorphic action representations, wherein a visual representation changes as a function action, command, or time. The following are examples intended as descriptive and not as having limited effect. Any selection of a representation is encompassed with this disclosure. Geometric, color, light, type, audio, visual, haptic, and holographic forms are equivalents. For example, as a red encircled icon and a blue icon-in-a-square are equivalent so are audiovisual representations of an action, command, display, feature, and visual in any figurative, illustrative, descriptive, depictive, indicia, reference form, and combinations thereof in whole or any part.

Representations may be utilized as such to perform action on, refer to, and/or send a command to for for a record. Representations may be illuminated, visual, audial, haptic, and combinations thereof. Representations may change color, have opacity, hue, saturation, invisibility, and each of these may change according to mouse or navigation features. For example, a next-button (triangle-triangle-bar-encircle) may be invisible or partially visible until a mouse navigates to an area where the visual representation appears or a voice command may cause the navigation to appear, a voice command may cause the responsive representation to show responsiveness, a voice command and mouse command, for example, may be used in unison or conjunction, have polymorphic effect, be responsive to actions, commands, interfaces, present new actions, representations, commands, interfaces, scripts, and forms, as well as portions thereof, parts thereof, combinations thereof in any partial or whole form or format.

Affect Representations include type, characters, and/or emojis referring to any written-, emotive-, affective-, feeling-, gestural-, signed-, or spoken-language. An example may include the use of emojis to represent affective states that represent the sense of a person about an activity in historical, present, future time, and combinations thereof. Affect representations may refer to intuited or interpolated affectives, and affects, through a summary engine that represents an affective state according to one or more affect data. Affect Representations may refer to and/or replace reviews, function as, and/or utilized in addition to reviews. Affect Representations may for example refer to a person's or an electronic's affective response to one or more of, for example, an activity, appointment, schedule, person, event, and combinations thereof. Affect Representations may refer to the affective responses of another person, people's, electronic's, affective responses. Affective Representations may symbolize an affective state of a review, an emotive response, feeling, intuition, sense, of one or more people, electronics, indicia, reviews, monitored reactions, statistics, and combinations thereof.

Action Representations are depicted as a finger or hand gesture with an action associated therewith. A thumb or index finger may be used to swipe. An index finger may be used to tap an action area. A mouse may be used to click an action area. A tap-and-hold may show a strength or indication of degree. Such as a tap may be held for one to five seconds to indicate how much a person likes something. An action interface or action area may be responsive in terms of color, type, visual, look, and feel in terms of representing affect. A tap for one second may represent a cool lukewarm liking while a tap and hold for five seconds may indicate a red-hot love. A polymorphic action area may be a representation in series or instance.

Alert Representations include for example an exclamation mark in triangle (!-in-a-triangle). Alerts may represent data that pertains to the record for a person or electronic to for example read, see, hear, feel, taste, or smell. Alert Representations may furthermore refer to a scheduling or calendar conflict. Alert Representations may be sent to a schedule or booking engine by another engine, API, software, interface, person, address, listener, handler, activity, record, event, scheduler, clearinghouse, electronic, and combinations thereof.

Audio-visual representations may be navigate through records. For example, a play-button (triangle-encircle) may record a record. A stop-button (square-encircle) may stop an activity or unschedule an activity. A x-button (x-encircle) may delete an activity or person. A pause-button (upright-=circle) may unconfirm one or more of and not limited to an activity, appointment, confirmation, invitation, or participant. A next-button (right-pointing triangle-triangle-bar-encircle or right-pointing triangle-bar-encircle) may go to the next record, person, name, date, time, type, price, shipping method, review, service, affect, advertisement, interface, action interface, command, display, action area, button, portions thereof, and combinations thereof. A previous button (left-pointing triangle-triangle-bar-encircle or left-pointing triangle-bar-encircle) may go to the previous record, person, name, date, time, type, price, shipping method, review, service, affect, advertisement, interface, action interface, command, display, action area, button, portions thereof, and combinations thereof.

Connectivity representations include, for example, a paper airplane, or a folded piece of paper in a triangular form, may refer to sending a sms text message. A telephone handset receiver may refer to making a telephone call. A video camera may refer to placing a video phone call. An envelope may refer to sending an email. A silhouette may refer to a person, persons, or a group. Adding, or subtracting a person, may notify a person or electronic of a revised schedule, booking, payment, and any needed record. A dialogue-box may refer to a sms, to a chat, to message sent in a chatroom, and to any usage of a type message.

Currency Representation includes a dollar-button ($-encircle) may represent, refer to, and/or respond with data, form, and/or script pertaining to a unique price, a non-unique price, cost, payment, and combinations thereof. Any currency or coin representation may similarly represent, refer to, and/or respond with data, form, and/or script pertaining to a unique price, a non-unique price, cost, payment, and combinations thereof. A check-button (checkmark-encircle) may represent and/or respond with data, form, and/or script pertaining to one or more of and not limited to an appointment, booking, check-in, confirmation, participation, reservation, record, schedule, and combinations thereof.

Numerical Representations include for example, an integer, fraction, numeral, decimal represents data that pertains to a record. Any natural number including zero may be visual representations as well as any mathematical symbols that represent data in any intuitive-, semantic-, known-, software-way, -mean, -manner, -figure, -gesture, and combinations thereof. For example, a number one-button (1-encircle) may represent one participant, ranking, or ordinal. A 5-button (5-encircle) may furthermore represent a rating, for example, or a time of day. Numbers may also refer to ordinals, including priorities, timeline, orders, sequence, steps, lists of records, entries, participants, seating arrangements, schedules, records, and combinations thereof. A circle without contents may represent an absence of data or action interface that may optionally have data specified. For example, a circle-without-contents could represent an open option or represent an unspecified participant.

Record Representations include for example a plus-button (+-encircle) may add, for example, any activity, affect, appointment, confirmation, invitation, participant, time, date, location, cost, payment, record, rule, relations, and combinations thereof in part, in portion, and/or in whole. A minus-button (“−”-encircle) may subtract, delete, cancel, cancel-with-notice, cancel-without-notice, remove, unconfirm, uninvite, retract an invitation, negate a rsvp, for example, any activity, affect, appointment, confirmation, invitation, participant, time, date, location, cost, payment, record, rule, relations, and combinations thereof in part, in portion, and/or in whole. A plus or minus button may added or subtracted in relation to an action, command, display, action interface, or polymorphic action.

Record Representations include an information-button (i-encircle) may respond to click, tap, and/or voice command with a form and/or script that allows a person or electronic to input data about an activity. Next, a new participant may be added with a form and/or script that allows a person or electronic to add a person's name whom to add to the itinerary for the activity. A plus-button (+-encircle) may respond to a click, tap, and/or voice command with a form and/or script that allows a person or electronic to input data. An activity may be added on behalf of participants by selecting an open circle to designate one or more additional participants. A play-button (righthand triangle-encircle) may respond to a click, tap, and/or voice command with a form and/or script that allows a person or electronic to store an activity record in an itinerary. A name, reference to, or data for an activity may be entered in a text box and the information sent to a search engine or scheduling engine for a categorized activity. A magnifying glass may respond with a form and/or script to a key command, click, tap, and/or voice command for a person or electronic to search for a type activity. A question-mark-button (?-encircle) may respond to a click, tap, and/or voice command with a form and/or script that allows a person or electronic to store an activity record in an itinerary.

Record Representations include a new participant or participants may be invited to the activity. An at-button (@-encircle) may respond with a form and/or script that allows a person or electronic to add a person's name to whom a scheduling engine sends an invitation. An invited participant as a person may then accept or decline an invitation for an event, or a an invited participant may have an electronic accept or decline an invitation for an event based on one or more rules such as and not limited by cost, time conflict, and/or place limitation and/or based on one or more relations such as and not limited by incompatible affect, activity purpose, and/or named persons.

Record Representations include a media posting may be preset, or added, to an activity so that a posting appears on a social network or social media website. A hashtag-button (#-encircle) may respond with a form and/or script to a command, click, tap, and/or voice command in order to schedule a media posting and associated with a profile of a person or electronic for whom the itinerary is prepared or displayed. The media posting may be transmitted to one or more of any networked device, software, or platform such as for example and not limited to a social media platform such as TWITTER, a social network such as INSTAGRAM, and a social interest platform such as PINTEREST. Further, media postings may be scheduled and transmitted or posted on behalf of participants in the activity through a scheduling engine. Posting rules and relations may be defined by one or more of and not limited to a scheduling engine, booking engine, social network, social media platform, profile for a participant, and combinations thereof.

Review Representations are referred to with stars, type, and any visual representation of a review including one or more of and not limited to numerical display, hand gestures, palm gestures, balloons, fingers, and combinations thereof in part, in portion, and/or in whole.

Symbolic Representations include visual representation of any one or more physical articles such as, for example, an airplane, train, or automobile. Symbolic representations include icons that refer to digital representations of any one or more of electronic articles such as, for example, a calendar, mobile telephone, computer, audio player, and tablet. Symbolic representations include any one of or more of for example representations of activities, events, conveyances, persons, images, videos, reviews, and advertisements.

Symbolic Representations are a digital reference to an affect, physical, or digital form. Symbolic representations include icons. Symbolic Representations utilize an icon to refer to one or more of and not limited to an action, command, display, interface, action interface, form, script, combinations thereof, and in any partial or whole form or format or representation. Icons include for example, a calendar icon that represents a calendar, a schedule icon that represents a schedule, a quotation icon that represents a review, a credit card that represents a digital payment, a credit card represents a credit card in a profile that may be processed upon clicking a book new in order to schedule a booking, a dollar-button ($-encircle) that represents a unique price, a checkmark that represents a confirmation, a shield represents reviews, a tile represents a schedule, gears represents an engine, a cart represents a shopping engine.

Symbolic representations include a location marker, pinpoint, activity designation. An activity designation includes for example a movie reel represents a display referring to a movie activity. Type character sets are symbolic representations. QWERTY-keyboard, ASCII symbols, character sets, script languages, special characters, glyphs, for example, are symbolic representations. Any pictorial artwork, illustration artwork, emoji artwork, icon artwork, graphic, artwork in general or specific form may be utilized as a symbolic representation.

Requesting input or provides a communication port for input of data.

Respond replies to a request for example by an action, command, display, engine, interface, and transmission. Responses may comprise one or more data, feature, or record.

Retrieve comprises one or more requesting, providing, and receiving data or a record.

Revised includes one or more of and are not limited to change, adjustment, modification, addition, subtraction, deletion, or cancellation. Revised pertains to any of appointments, bookings, calendars, costs, payments, or schedules.

Rule includes one or more settings and is not limited to a function, parameter, variable, or value that pertains to any instance of a schedule, an activity, appointment, booking, calendar, cost, electronic, event, feature, good, payment, person, ticket, or service. Rules pertain to things that constitute an instance, such as an appointment's date, start time, end time, number of attendees, size of a wait list, and cost. Rules also may be revised, prioritized, ranked, sorted, allocated, apportioned, combined, separated, fenced, offset, subject to quota, rationed, subject to override, subject to exclusion, subject to exception, exempted, restricted, limited, waived, grouped, selected, matched, corn pared, quantified, parameterized, checked, validated, verified, authenticated, authorized, generate an alert, generate a notification, or combinations thereof.

Rules comprise functionality set forth for example in software, platform, scheduling and booking including and not limited to the APIs, SDKs, references, and documentation listed in the Incorporated by Reference Section, namely of Adobe Systems Incorporated, Apple Information Technology Company, Booking dotcom Travel Booking Company, Google AdWords, Google Calendar, iCal Computer File Format, Expedia Travel Booking Company, Facebook Social Networking Company, FareHarbor Booking Company, Instagram Social Networking Service, LinkedIn Professional Services, Oculus Virtual Reality Company, PayPal Online Payment Company, Reddit Social News Company, Stripe Payment Company, TripAdvisor Travel Company, Twilio Cloud Communications Transmissions Platform, Twitter Social Networking Company, Uber Ridesharing Booking Company, WhatsApp Mobile Application, YouTube Video Sharing Company, and ZenDesk Customer Service Software Company.

Examples of rules for an activity include for example and are not limited to number of participants, location, type, exertion level, age group, amount of prior experience, and so forth.

Examples of rules for a booking include for example and are not limited to cost, payment approval, age of people in party, daytime availability, night availability, size of room, bed size, and so forth. Rules may include one or more of and are not limited to airline, banking, finance, financial services, rentals, short-term rentals, real estate, actuary, insurance, claims, mortgage, lending: travel, education, learning, clinical environments, hospitals, medical services, professional services, evaluations, testing environments, clouds, construction, home services, housekeeping, construction, maintenances, repairs, travel, tourism, transportation, restaurants, reservations, tables, seating, shipping, docking, harbors, scheduling, computers, manufacturing, networks, resources, tourism, ticketing industries, and combinations thereof. Rules pertain for example to a schedule of time and/or money. Rules encompass for example any hours of the day, night, between one or more days, future, or in the past. Rules may be constituted for example according to calendars, timetables, timelines, chronologies, itineraries.

Examples of rules for a calendar include for example and are not limited to bookable hours, bookable inventory, time between appointments, length of appointments, viewers of a calendar, public calendar, private calendar, and so forth.

Rules for costs include for example and are not limited to rates, seasons, peak times, ranges, thresholds, minimums, maximums, discounts, coupons, group pricing, custom pricing, and unique pricing.

Rules of an event include for example and are not limited to date, time, number of attendees, number of tickets, types of tickets, seat numbers, seat areas, seating groups, rewards, incentives, backstage privileges, VIP privileges, and policies.

Rules of a feature include for example and are not limited to those that constitute a venue, movie, flight, concert, comic, performance, art, theater, headliner, televised show, channel, network, video stream, audio stream, interview, broadcast, peer-to-peer cast, play-back, recording, demonstration, protest, election, or the constituent elements of any activity, event, production, service, combinations thereof, in whole, or in part.

Rules of a good include for example and are not limited to type, size, cost, weight, contents, carrying bag, wrapping, designed age group, label, shipment type, shipment speed, deliverable, tariff, tax, and so forth.

Rules of a payment include for example and are not limited to cost, currency, type of payment, type of credit card, tax, transaction details, reference codes, and conversion rates.

Rules for a person include for example and are not limited to age, sex, ethnicity, religion, race, national origin, sexuality, gender, and so forth to include categories, types, labels, attributes, as well as constituent factors that are described with non-conventional labels such as bi-racial, multi-racial, cis-gender, trans-gender, non-binaries, intersectional, interpolative, combinative, positivistic, negativistic, affirmative, inclusive, exclusive, and combinations thereof.

Rules for electronics include for example and are not limited to parameters and functionalities of the electronic that define how to use the electronic including the scope, purpose, APIs, inputs, and outputs, such as a scheduling engine that responds to typed or audible input, is accessible through voice Application prompts or API, and outputs are in narrated format, visual display, or combinations thereof. Rules of a electronic include rules for an activity, appointment, booking, calendar, cost, event, feature, good, payment, person, another electronic, ticket, service, and combinations thereof.

Examples of rules for a ticket include for example and are not limited to one or more headliners, an act, acts, cost, location, date, time, a number of participants, location, in addition to those of a feature, and combinations thereof.

Examples of rules for a service include for example and are not limited to those of an activity, appointment, booking, calendar, cost, event, feature, good, payment, person, electronic, ticket, service, and combinations thereof. Services pertain to actions rendered for a person or electronic. Services include those for known services including and are not limited to cable services, cloud services, communications, home services, human services, education services, financial services, food industry, legal services, media services, networks, new services, professional services, telecommunications, transportation services, satellites, shipping services, social services, and utility services. Services also pertain to for example and are not limited to one or more experiences, culture, knowledge, learning, processes of artisans, processes of crafts, persons, experience, expertise, skills, talents, gifts, goods, interests, dating, socializing, social media, shipping, and combinations thereof. Services may be searchable by commands, searchable with a scheduling engine, and bookable with an interface.

Known rules that pertain to settings for any of these types of instances, categories, or combinations thereof are within the scope of invention for embodiments described and envisioned herein. A rule may be an affect, label, category, delimiter, heat map, ZIP code, search filter, filter, toggle box, check box, ticking, radio button, name, cost, range, or slide.

Sequence is a ordered list or ordinal set of one or more and is not limited to bookings, interactions, iterations, itineraries, locations, places, searches, schedules, timestamps, points in time, traversals, conditionals, rules, relations, in whole, in part, and combinations thereof.

Transmit or transmission is a way of sending or communicating data from a person to another person, from a person to an electronic, from an electronic to a person, from an electronic to an electronic, and combinations thereof. Transmissions may be for example sent through a wired connection or wireless connection. Transmissions may be for example initiated by an engine and handled by one or more of a person, an action, a command, a display, an electronic a device, interface, software, an API, and combinations thereof. Transmissions may involve method steps for example and not limited to registering, requesting, retrieving, responding, sending, storing, pricing, and paying.

Traverse/traversal is an iteration through a schedule or data in a sequential process. A traversal may be an iterative or recursive process. A traversal may include one or more of and is not limited to a command, request, receive, or retrieve. A traversal may generate a rule, a relation, a display, interface, interaction, visual, audible, haptic, data, and combinations thereof. A person traverses data in a display. A results list is a traversal of a set of data. A electronic may sort, select, record, or generate a report by traversing data. A traversal may include a step in a graph, neural network, tree, stack, database, data structures, or token. Traversing data is performed through relational database operations including one or more of and not limited to a table, function, map, mapper, report, conditional, parameter, statement, join, trigger, and event.

Type includes and is not limited to an input or response on a physical or virtual keyboard or keypad that is actioned with digit such as a human pointer finger/digito or caused to transcribe a letter, word, phrase, command, or sentence into a written language, cipher, emoji, sequence, text, and combinations thereof through an audible, visual, person, or electronic input. Type may be presented on a display or visual. Type may be presented in any typeface, font, size, color, language, symbol, semantic, cipher, modification of text, shaping of letters, script, character set, combination with one or more visuals, or unicode effect on text. A type and kind may also be used interchangeably to refer to species or group of related items.

Visual includes and is not limited to one or more of a graphical interface, screen display, emoji, line, pattern, web, stencil, overlay, script, javascript, popup window, a polymorphic action, template, animation, image, photograph, figure, cart, chart, indicia, stars, review, icons, symbol, schemata, blueprint, diagram, illustration, a touchscreen, monitor, video, movie, stream, optical system, hologram, virtual reality, augmented reality, GUI window, or combinations thereof.

Definitions also pertain to known uses and definitions in spoken languages, written languages, electronic programming languages, business marketplaces, and consumer marketplaces.

Definitions are meant to be substituted interchangeably in the instances utilized to provide descriptions of embodiments. Definitions provide a genus with examples being species comprising said genus. Examples of species may be substituted interchangeably and in combination within the scope of preferred embodiments. Citations that are incorporated by reference provide preferred definitions. Definitions in citations provide genuses with examples being species comprising one or more genuses. Examples of species may be substituted interchangeably and in combination within the scope of preferred embodiments. Species and genuses may be grouped in other genuses and with others species. Multiple groupings in one or more other genus and species are within the scope of the preferred embodiments. Definitions provide examples of preferred embodiment rules and relations that may be claimed. Methods and processes defined in definitions and citation definitions may be improved upon with the descriptions and embodiments contained herein. Improvements to known scheduling, booking, and payment methods are within the scope of claimable inventions comprising said definitions.

As defined herein, all definitions pertain to any aspect known to a field and may be used interchangeably. Applicant is own lexicographer. Any contradictory definition, description, rule, or relation is unintended and shall not be construed in any part so as to limit, narrow, or negative the embodiments claimed, contemplated, described, illustrated, and set forth herein. A rule as defined herein may pertain to, for example, a banking industry regarding a scheduled balance due, compounded interest, or a payment regulation, and may be utilized by one or more of the embodiments that are claimed and envisioned of the present invention. Similarly, relations that are utilized in interfaces, for example, may also be utilized by the embodiments that are claimed and envisioned in the present invention. Definitions may be specified according to existing or known definitions in related fields and industries and are incorporated herein. Furthermore, rules and relations may be promulgated according not merely to genus-species relations but also to Linnean hierarchies, statistical associations, neural networks, and machine learning.

### Descriptions

### Scheduling, Booking, and Pricing Engines

A preferred embodiment prepares a timeline of destinations for set period of time, such as an afternoon of after school activities and running errands. Distance between destinations varies according to time of day and traffic. A sequence of destinations is dependent upon available time as well as conditions of travel. There are amounts of time that a person estimates may be spent at a destination. Relations pertain to the types of factors that cause effect between destinations, for example. These may be set by a person or by variables according to travel conditions. Rules in this embodiment may pertain to, for example, a necessary stop, optional stops, a final destination, and an optional starting point. One or more rules may also be set e.g. according to a desired time, destination along the way, to a shortest path sequence, to a shortest wait sequence, minimal idling, scenic route, detour, rendezvous, or rendezvouses.

The method of preparing a destination schedule allows a person or electronic method to set an origin point. One or more destinations are set, along with the intermediate destinations, final destination, time at a destination, and one or more availability that pertains to, for example, a time of day, a set appointment, a rendezvous, and/or day of the week that the destinations may be scheduled. Rules may be further set as well as any relations among or between destinations or routes. Relations among destinations are requested, according to rules that pertain to one or more destinations and including for example the travel time between destinations. Relations may be requested from mapping services, navigation services, GPS services, ride sharing services, Applications, and Application Programming Interfaces (APIs) that provide details pertaining to travel estimations and conditions. The relation data is received and provided to an algorithm that determines one or more sequences of destinations. The sequence may pertain to the one or more destinations, rules, and relations, and does not necessarily meet all criterion.

Sequences are displayed or presented to a person or electronic method. The person or electronic method selects a sequence of destinations. The person may save the sequence for a future time, a future date, or may begin travel around the time of selection. The sequence may also be scheduled for future notification when criterion of relations meet one or more availability or rules. The sequence may also be sent to another person or electronic method that operates a conveyance to iterate through the travel sequence. A sequence may be revised, added to, or updated at any time along the timeline, before, or after conveyance commences. Updates may reflect changing traffic conditions and impact the sequence of destinations. Further, alerts may be sent to a person or electronic method regarding the arrival at a destination, new rules, and changing relations among destinations. A person or electronic method may also request updates about status or request revisions to the schedule at any time before, during, or after the schedule commences.

Schedules may be saved, repeated, adjusted, and modified by persons or electronic methods that are doing, monitoring, or controlling the conveying. Schedules may receive input from persons and electronic methods regarding real-time updates about availability, duration, readiness, inventory, and sales that may impact the rules or durations at a destination. Real-time updates may be used to revise the schedule of destinations for a particular time. Destinations may be shuffled according to one or more real-time updates, changing relations, and updated rules about the schedule.

A preferred embodiment display or presents a booking event or transaction to a person or electronic method. The booking may be for a schedule, appointment, activity, event, or even a waiting list. The booking display may include a button that appears on a device. A booking presentation includes an interface or interaction that is visual or audible. The booking event or transaction may also include a payment or be a payment for a service or good. The booking may include a button or actuated interface in visual, typed, haptic, or audible forms. The booking may pertains to a person, individual, group, entity, or place. For example, an available time or appointment for a person for booking is presented on a device. The action of booking secures the time or appointment for the person that books. The booking may be a peer to peer booking. The booking display may be a direct presentation of a person's schedule for booking. The booking display may be a stand-alone electronic method or interface.

The booking display may be integrated into a electronic method or interface that presents identifying information of the person in a booking interface such as a clickable button or audible interaction. A sequence of booking that includes one or more visual, audible, haptic, and typed forms is a booking presentation. A sequence of inquiry regarding booking includes one or more visual, audible, haptic, and typed forms is a booking inquiry presentation. Booking presentation and booking inquiry presentations both include identifying information for the person, and may include rules, relations, time, location, date, year, calendar day, latitude, longitude, and ZIP code. The presentation may use any calendar, ordinal representation of time, cipher, and language to implement the display of information in the booking presentation.

The booking may or may not include a payment or cost for booking. A booking may require a payment, may require a future payment, may not require a payment, or may generate a payment. The booking display may present a cost, be costless, or a compensation booking. A cost presented at booking represents a booking that requires a payment. A compensation booking is a booking that generates a payment for a person or place. A profile may be used to link payment information to pay for a booking or to receive payment for a booking. A booking presentation may generate a cost with a command or instruction. The booking display may include ways of making a payment at a booking action interface, before a booking command or instruction, or after a booking action. A cost

In order to pay for a booking, the booking display may also split the cost among more than one person, entity, or group. One or more sources of payment for a booking may be linked or represented at, before, or after a booking. A source of payment may be predetermined by a person and made available for booking in a profile or at a transaction. A source of payment may be linked to another person or to another payment account or payment device. A booking display may include an interface to gather or capture payment information about a payment account or from a payment device. A booking display may include an interface to input information about one or more payment accounts. A booking display may include an interface to select one or more payment accounts. A booking display may include an interface to apportion or divvy parts of a payment to one or more persons, payment accounts, or payment devices.

A payment may be combined, separated, deferred, or bundled from more than one source at the time of booking. A bundled payment includes authorization or consent from more than one person to account for part or whole of a cost of booking. A schedule of payments may be presented along with identifying information such as an address, number, or alphanumeric representation in order to link to or account for a payment, either in whole or part. A link to an payment includes a real-time transaction or acknowledgement of debt to be paid. An account for a payment may include a banking account, credit card account, currency, barter, bid, electronic currency, smart contract, and smart ledger.

The processing of a transaction for booking may include a scheduling interface for one or more sources of payments to post. A link to a payment may account for more than one person or more than one account for bundling a payment or processing a transaction. A bundled payment or transaction may include a payment voucher or future debt owed with or without any monetary transaction. A bundled payment or transaction may include a portion of payment and a portion of future transaction such as a scheduled payment. Payments may include portions or a whole amount derived from a reward electronic method, subscription, and payment plan. Payments may also include superadded portions such as interests, financing fees, transaction costs, booking fees, tolls, goods, and taxes. Payments may also include monetized soft forms without currency used to represent value of time, appointment, or transaction. For example, a person's time may be used to pay for a booking of another person's time. Additional monetized soft forms may include one or more of a voucher, tasks, schedules, events, activities, or contract.

A booking display or presentation may include a searching interface to display a person or place. The display or presentation may include a searchable availability interface for finding a time or appointment according to a time and date of interest, rules, and relations. The interface may provide a searching engine for a person to search for available appointment times, scheduled time, or bookable event. The searching engine may be an action interface that responds as an interface. An action interface may respond to person or electronic method instructions in order to request and receive information from a person or electronic method. Actions may include for example instruction or command. Instructions may include one or more interfaces or electronics to navigate or convey displays through electronic interfaces. A command may respond to information that represents another person or place such as a name, identification number, location, swipe, beam, or directed data transmission. Any form of representation, cipher, hotkey, swipe combination, combination of keys, meaning phrase, safe word, predetermined codes, preset buttons, or preselected combinations may be used to refer to commands or instructions.

A searching engine for bookable or schedulable time includes an interface. The interface is responsive to commands and presents data in a display or interface. The searching engine may pertain to one or more person, place, or group. The searching engine is an interface for a person or electronic method to send commands that query, find, or locate a person or a place. Identifying data may be used to locate a person or place for bookings. Identifying data may include a name, identification number, telephone number, alphanumeric string, QR code, barcode, and any audio and/or visual representation such as a photo, video, or voice print. Identifying information may also include GPS coordinates, biometrics, and metadata that refer to a person with anonymous, personal, or personalized reference. The searching engine responds with information that identifies or references a booking or a bookable event, activity, appointment, schedule, availability, time, location, and place. The searching engine may respond with a command, a bookable command, a booking button, or booking interface

A booking may generate payment to one or more accounts. A schedule may be set to disburse funds into one or more accounts at a later date. Rules and relations may be implemented in a profile in order to schedule payments or disbursements of funds. Schedules for example may include at the time of booking, predetermined accounts, future payments, and disbursements. Rules may include preset amounts such as as minimum payments, target account balance, and addresses for directing proceeds from one or more payments to one or more accounts. Relations may include addresses, conditions, conditionals, equations, formulas, and amounts that specify a payment account or destination for a payment, part or whole.

A purchase may generate debits from one or more accounts. A schedule may be set to withdrawal funds into one or more accounts at a later date. Rules and relations may be implemented in a profile in order to schedule payments or withdrawals of funds. Schedules for example may include a account statements, a credit card account, statement, predetermined accounts, future payments, interest, incentive programs, rewards, and payment plans. Rules may include preset amounts such as as threshold amounts for purchase, bundling monetary resources to make a purchase, bundling monetary resources to make a payment, desired quantities, existing inventory, addresses for directing one or more sources of payments to one or more purchase, and addresses for directing one or more sources of payments to one or more accounts. Relations may include addresses, conditions, conditionals, equations, formulas, and amounts that specify a payment account or destination for a payment, part or whole.

### A Unique Pricing Engine

A Unique Pricing Engine generates pricing for a product or service according to customer-specific information that is used to calculate a unique price. Furthermore, manufacturers, merchants, wholesalers, producers, retailers, and suppliers may also provide unique prices that provide their products and services a competitive advantage. Namely, a provision of cost buffering allows the unique price that a customer pay to be lower than a price competitor. The unique pricing engine may hold a cost buffering resource that subsidizes prices for customers. Furthermore, the cost buffering resource is supplied with resources that may be monetized and reduce the price that customers pay. Such resources that supply cost buffering include, and are not limited to, automated bartered goods and services, optional price overrides for customers who select performance pricing strategies, credit systems that count sales towards rewards, volumetric cost derivatives, as well as through direct monetary contributions. The resource buffering resource allows the engine to set pricing points that are generated according to desired ranges for a merchant service. The unique price presented to a customer may be higher or lower than a customized price.

In preferred embodiment, the unique pricing engine generates a price for a product or service that is unique for the customer of that product or service. The price offered to the customer is calculated according to parameters set by both the manufacturers, merchants, wholesalers, producers, retailers, and suppliers as well as the customer. The parameters that a customer sets include, for example, cost of living, standards of living, local standards, aggregate standards, family status, marital status, education level, amount of time, time of day, availability, per diem, income level, tax bracket, ZIP code, extended ZIP, volume of transactions, profit margin, and a charitable giving option. Parameters may also be set on behalf of the customer, and vice versa. In some cases the provider of a product or servicer may also set identical or similar parameters. A customer could be an individual, collective, coop, group, or a legal entity such as a corporation. The parameters that an entity customer or provider sets include, for example, actuarial metrics, customer analytics, market discounts, tariffs, surges tax credits, tax strategies, investment strategies, numbers of transactions, pricing agreements, inventory, supply, demand, transaction costs, advertisement analytics, performance analytics, click metrics, and so on.

The unique pricing engine allows the manufacturers, merchants, wholesalers, producers, retailers, and suppliers to set their own costs. The aforementioned systems for determining such pricing—customized, personalized, tailored, optimized, markup, markdown, adjusted, discounted, dynamic, and/or prioritized pricing—may provide their settings. While the unique pricing that is generated by the engine may also be factored into the pricing systems. The purpose of the unique pricing engine is to provide competitive advantages to both the customer and to the manufacturers, merchants, wholesalers, producers, retailers, and suppliers. The benefits of the engine include increased revenue, marketing incentives, brand recognition, improvements for the social good, and strategic development of branding.

A Unique Pricing Engine can preferably be configured through a graphical user interface that allows a customer to set the factors that are used to generate the unique price. A customer creates an account and registers their personal identity information. The interface provides input fields for the customer to specify information that is public, sensitive, and/or private. For example, the customer inputs the name, age, marital status, number of children, tax bracket, taxable income, education level, and zip code. The engine gathers personal, quantified, and statistical information related to the customer, the neighborhood, city, and state. More detailed information may also be provided according to tax transcripts, liens, debt accounts, credit report, credit score, driver's license, insurance history, background check, behavioral metrics, click history, and other data metrics that allow a customer's context, resources, identity, and habits to be articulated in parametric form. These detailed data about a customer are used to calibrate the purchase capacity of a customer for a given product.

In a preferred embodiment, a user registers at a digital interface to the Unique Pricing Engine and provides data in the input fields. Parameters are used to determine a variable pricing index. An index is generated with the data from the input fields. For example, a customer having a large family with an income that is on par with the national average may have an index greater than a set pricing threshold. A set pricing threshold may be a simple price of good sold before fees are calculated for taxes, shipping, handling, and/or connectivity fees. A set pricing threshold may be used to allow a customer or a provider to request a price engine alteration, to set a price limit, redisplay prices with or without fees, price bidding, peer group combined purchasing, collective purchasing, bulk discounting, surge pricing, increase/decrease gift levels, and priority purchase positions. A customer index then may be used to reduce the price of a product. Another customer may have an income higher than the national average and have fewer dependents. In this case the customer index increases the price paid for a product. The price paid could be higher or lower than a benchmark price that a provider sets. The resource buffer account may be debited or credited according to the price paid for a product or service by a customer. A customer's input factors are used to calculated a weight, coefficient, variable, or numerical factor to the pricing index according to a customer's purchasing capacity, local standards affordability, risk factor, and customer history. Furthermore, a pricing index could be generated according to aggregate standards, socio-economic statistics, demographics, housing metrics, or other impersonal sources of data that may be used to further resolve or float the unique price that a customer pays for a product or service.

A customer pricing index may be a multiplicative coefficient or denominator value that allows the product price to be determined according to the unique personal identity information. The numerical value of the data input into these fields may increase or decrease a variable pricing index. The engine may implement multiple pricing indices for a customer according to the cost of a product. These data inputs may be stored in an account, on a portable data device, a chip card, a magnetic strip card, or may be inputted on demand. The data may be stored and accessed when needed, only one time, or used a set number of times.

A provider such as a manufacturers, merchants, wholesalers, producers, retailers, seller, suppliers, or servicer registers data input relating to the price of a product or service. The data could be a benchmark price of a product. The pricing data may also be a price determined according to aforementioned methods and systems that calculate prices according to customized, personalized, tailored, optimized, markup, markdown, adjusted, discounted, dynamic, and/or prioritized pricing. A benchmark price may be determined according to inventory, bulk discounts, supply chain costs, and pricing plans. Moreover, a provider may input similar or identical information that a customer provides in order to determine a provider pricing index. A provider pricing index may be specific for an individual or entity. The pricing index may be increased or decreased according to the provider's selling capacity, local standards affordability, advertising, sales and marketing, incentives, risk factor, and sales history.

For servicers, the provider pricing index allows individuals and entities to increase or decrease a price for a product or service according to name, age, marital status, number of children, tax bracket, taxable income, education level, and zip code. More detailed information may also be provided according to tax transcripts, liens, debt accounts, credit report, credit score, driver's license, insurance history, background check, behavioral metrics, click history, and other data metrics that allow a provider's context, resources, identity, and habits to be articulated in parametric form.

A provider pricing index may be a multiplicative coefficient or denominator value that allows the product price to be determined according to the unique personal identity information. The numerical value of the data input into these fields may increase or decrease a variable pricing index. The engine may implement multiple pricing indices for a provider according to the cost of a product. These data inputs may be stored in an account, on a portable data device, a chip card, a magnetic strip card, or may be inputted on demand. The data may be stored and accessed when needed, only one time, or used a set number of times.

The Unique Pricing Engine may be accessed through a graphical user interface on a third-party website, through an Application Protocol Interface (API) that integrates the functionality into an existing website, through a back-end calculation system that generates customized pricing, or through a portable payment device for use at a point of sale system or as a point of purchase system. A point of purchase system processes sales on behalf of a seller to one or more seller, manufacturer, merchant, wholesaler, producer, retailer, and supplier. Such portable payment device, purchase card, or point of purchase device may furthermore include a smartphone, credit card, push-button payment system, or click channel that performs, initiates, connects, or completes a transaction for a sale, order, refund, automated clearinghouse, or any such merchant transaction. In another preferred embodiment, the Unique Pricing Engine is a calculation layer called by an API that may be instantiated at any point or points in the purchase-sale transaction sequence starting from raw materials and completing in product delivery. The Unique Pricing Engine may also preferably be a calculation layer called by an API that may be instantiated at any point or points in the purchase-service transaction sequence starting from initiation of service request and completing of service rendering.

The Unique Pricing Engine may be implemented in such a way that the resource buffer is held for specific individuals, entities, or common amongst individuals and/or entities. For example, a large seller of products may instantiate one or more resource buffers in order to distribute funds from the same of one product category or another. A larger seller could increase prices according to market demand in order to offset costs in other product or service areas. Rather than providing access to resources that could be used as coupons, by comparison, the resource buffer may be available to customers who meet certain parametric criterion. The parametric criterion in this case may be the personal set of financial information such as for example taxable income, standard of living, cost of living, and family status. One of the uses of the engine would be to subsidize the cost of staples that a customer might otherwise not be able to afford. Staple products could be easily be subsidized such as paper products, disposables, comestibles, commodity, and sundry items. A large seller or products could supply resources to a buffer from a manufacturer, internal purchase incentives, through government subsidies, as well as through direct contributions from other customers.

A resource buffer may be implemented with a standard banking accounting system, automated clearinghouse, point of sale system, user interface, and/or a banking API The resource buffer may be held within a user interface of the Unique Pricing Engine, accessible through it, or external to it. A number of buffers may be used for various products or services, at the discretion of the provider or customer. The resource buffer may also be implemented by the customer in order to budget expenditures. The resource buffer may be implemented to provide parental and guardian controls, supplying of allowance resources, and tracking of expenses and/or purchases.

The supply and demand placed on a resource buffer for resources could be supplied from purchases of durable goods as well as titled and deeded assets. A nonprofit, municipality, religious organization, and/or governmental agency could organize a fund that is used for customers of specific zip codes and demographics in order to subsidize specific product purchases or services. Products need not be limited to staples and commodities. A for-profit organization could give a portion from their revenue towards a resource buffer from profits, advertisement revenue, earnings, and investment income. In an exemplary embodiment, retailers can integrate a unique pricing engine into their point of sale system, implement the Unique Pricing Engine as a point of purchase system, implement a cloud system for access to the Unique Pricing Engine, and/or implement a portable purchase device that generates unique prices for products and services at checkout. Rather than paying averaged retails prices for products, the Unique Pricing Engine in this preferred embodiment generates prices for each product that is purchased according to the resources of the customer. Organizations who offer a resource buffer would find advantages that are useful in attracting customers to a retail site, website, or through brand recognition, for their practice of providing support for customers whose resources are to varying degrees limited. The implementation of a Unique Pricing Engine could improve the click conversion ratio. Similarly, manufacturers, merchants, wholesalers, producers, and suppliers could implement an engine and/or buffer. Service providers could implement an engine and/or buffer for social services, internet services, cable services, delivery services, transportation services, subscriptions, insurance services, mental health services, physical health services, housing services, and health services in general.

In another preferred embodiment, the Unique Pricing Engine may be used to provide unique prices to customers according to an aggregate, a gauged, predicted, forecasted, behavioral, or set parameters. In a preferred embodiment, a seller of products provides an option to a customer to purchase at a price point higher than the average or customized price. Customers may have personal incentives to contribute in an altruistic or charitable manner to the benefits of others. A seller of products could create funds that are collected for altruistic price overrides wherein customers pay a top marginal price offset that is made available in the resource buffer for customers who may not otherwise purchase a product or as much of a product. A seller of products could create a charitable fund that collects donations and gifts on behalf of persons with restricted resources to include those of impoverished means, fixed income, limited income, disability, autistic, or other disposition that renders a person unable to earn or produce at a level that supports their well-being. Similarly, a service organization may also utilize a resource buffer in order to collect resources, distribute, redistribute, and/or subsidize the cost of services according to customer settings.

A preferred digital system embodiments of the Unique Pricing Engine also include a portable payment device that either holds in a data card having the input data from the customer, a pricing index, and/or connectivity to the a server or cloud system. The device may be a smart phone, credit card, chip card, or mobile point of sale device. A payment device may also have a resource buffer. A point of sale device may link to a server or inventory system that contains itemized records for goods or products. The point of sale device communicates with the portable payment device in order to generate unique prices for the products purchased. The point of sale device communicates with the Unique Pricing Engine through a computer, server, or cloud system in order to calculate a unique price or prices. The engine may be implemented as an automated clearinghouse that reconciles accounts with the payment for products sold and the resource buffer. The engine may communicate with a batch processing system in order to reconcile accounts for products sold and the resource buffer. The Unique Pricing Engine may comprise an account number and routing number for use with banking and/or credit card systems. A cloud system may host or communicate through an API with the Unique Pricing Engine, one or more resource buffers, a virtual point of sale system, the portable payment device, and merchant payment accounts.

A digital system may also be implemented for services as well as combinations of products and services. For example a Resource Card or a Reference Card may be used by the customer rather than a Credit. Card in order to pay for services. A resource buffer or buffers may be linked with the card in order to determine unique prices for services. The buffer could be linked to insurance cost matrices, look-up tables, actuarial calculations, plan coverages, and the like that calculate reductions in prices according to insurance package. The buffer could be linked to a Health Savings Account in order for account for costs covered by insurance or that are tax deductible and those that are not. The Unique Pricing Engine in this case serves as an intermediary between the customer, the insurance plan/company, as well as the service provider in order to determine costs, process transactions, as well as to credit and debit resource accounts accordingly. The digital system could be communicative with an Application Programming Interface to a credit transaction system in order to process payments from one or more accounts and/or resource buffers. A user interface could be accessible to the customer in order to track purchases, accounting, tax deductions, credit/debit their resource buffer/s. An insurance company may be a private company or a public government organization such as Medicare, Medicaid, or Social Security. The insurance company may provide resources in a buffer from third-party sources, government funding, gifts, loyalty points, incentives, cash rewards, etc. The resource buffer could be used as in incentive for insurance companies to reward customers for maintaining good health or good performance records. A resource buffer could be linked with biometrics and health maintenance programs. Performance records could be linked with health, driving, auto insurance, home owners insurance, and bundled services. Unique Pricing Engine interfaces between one or more insurance, provider agencies, customers, servicers, providers, parents, and dependents.

A merchant preferred embodiment allows a seller to expand the audience of customers, incentive structures, advertising revenue, and the programs designed to assist customers. The seller implements a digital system as defined above. A web portal allows the seller to offer unique prices to the customer for each and every product or service offered. The customer may input settings into their seller account for a Unique Pricing Engine. The seller may link the customer account to a central Unique Pricing Engine interface. The seller may implement one or more resource buffers. Resource buffers may be opened according to product family, brand, category, manufacturer, or supplier. Resource buffers may be opened for advertising purposes wherein resources are paid or given for a product in order to generate a unique price that is specific for each customer. The customer pricing index may be useful in order to fine-tune the amount from a resource buffer provided to subside the purchase prices of a product or service.

The customer pricing index may be useful in order to offset the price higher than the benchmark price in order to collect top margins from product purchases used to subsidize purchases by specific customers according to their pricing input settings. The seller may automate provision of a resource buffer according to purchase history, volume pricing, click analytics, navigation cookies, advertising resources, sales, and incentive programs. The Unique Pricing Engine provides an attractor for customers to see their unique price. The Unique Pricing Engine provides a service that is advantageous for sales and marketing for the common good, charitable purposes, and/or human good. A seller may utilize one or more tax-deductible, charitable giving, contributions from third-parties, and income revenue sources for resource buffers. The seller may develop provider pricing indices according to desired thresholds and levels of pricing points. The seller may develop customer pricing indices according to desired thresholds and levels of pricing points. The seller and the product representative may develop special indices for partnerships, seasonal sales, incentives, volume derivatives, and/or package bundles. The seller may provide incentives for streamlined production, integrated supply chains, favorable status, country of origin, trade standards, manufacturing standards, and production metrics towards pricing indices and resource buffers. The seller develops brand recognition and public trust for use of the engine, buffers, and indices.

A Unique Pricing Engine receives inputs from customer and a product provider such as a seller. Pricing indexes are determined for the customer and seller according to the inputs. Resource buffers for one or more of the customer and seller comprise monetary resources that buffer the difference between the seller price and the unique price paid by the customer. A Unique Pricing Engine determines unique prices for one or more products using the one or more resource buffers. The unique prices are displayed to the customer. Unique prices could be greater than or less than the provider set prices. A product purchase transaction is processed for the customer according to the unique price for one or more products. After one or more products are purchased by the customer, the resource buffers are then credited and/or debited accordingly.

Graphical User Interfaces. Exemplary Graphical User Interfaces are for customer, servicer, and provider inputs. Inputs are used to determine pricing indexes for a customer, service, and/or provider. Inputs may include one or more the following, as well as other quantified parameters that distinguish the uniqueness of a customer, provider, and/or servicer.

A Digital System implements a Unique Pricing Engine. A customer has as shopping cart comprising items for purchase. A purchase card is presented to a point of sale system for purchase. Alternatively a sales card is presented to a point of purchase system for selling one or more products to one or more seller, manufacturer, merchant, wholesaler, producer, retailer, and supplier. The point of sale device decisions with regards to the use of the card, sends the product SKU and customer identifier a cloud implemented Unique Pricing Engine. The Engine responds with a list of unique prices according to one or more pricing indices and/or thresholds. A product purchase transaction is processed for the customer according to the unique price for one or more products. After one or more products are purchased by the customer, the resource buffers are then credited and/or debited accordingly.

A standard merchant seller website and a merchant seller implements a Unique Pricing Engine. The standard seller website displays prices according to a standard price, such as a national standard price for a product and/or a service purchase in the United States. Customers select products for purchase, has tax and shipping fees added, and proceeds to a point of sale system for purchase. A merchant seller implementing a Unique Pricing Engine Application Programming Interface (API) provides a customer login. After logging into the seller website, the Unique Pricing Engine supplies customer index and resource buffer data to the website in order to determine unique prices for one or more products to the customer. Alternatively, the seller website may provide product. SKU numbers and pricing information to a Pricing Engine and receive unique prices for one or more products and/or one or more services. A customer selects one or more products and/or one or more services for purchase. A product purchase transaction is processed for the customer according to the unique price for one or more products. After one or more products are purchased by the customer, the resource buffers are then credited and/or debited accordingly.

### Financial Attribute Services

A secure authentication of identity commences first with receiving an identification number for a person or entity. An identification number or record is stored in a data memory. An identification number for a customer may be a Social Security Number. An identification number for an entity may be an Employer Identification Number. A data memory may be in the format of a solidstate device, or it may be a device that is on a network such as the internet, an intranet, extranet, deepnet, and/or a cloud. The identification record is held in memory that is accessible to a processor. The processor is able to make at least basic operations such as comparisons and computations. The processor interfaces with the data memory in order to retrieve at least a portion of the identification record such as a number.

For each unique identification number, a record also has stored a reference number that a consumer uses to reference an identity record. The identification number in this example may be a Social Security Number. While a reference number comprises a portion that the consumer may use for applications and forms rather than the Social Security Number. The reference number may comprise a static and/or dynamic portion. The reference number may mask or encrypt the identification number. The data record comprises at least equivalent identifying features of the identity of a person.

The processor receives a reference number for the purposes of authenticating the identity of a consumer. The processor also receives identifying information about the person's identity. The identifying information may comprise information that is public and/or private. The identifying information may accompany the authentication request at the time of receipt, or according to a desired time differential. Public identifying information may include an address, telephone number, or any kind of information that is available on a public record. Private identifying information may include identifying features that are known privately by the consumer, such as biographical details, taxable income, and/or personal information. The identifying information may also include a private verification protocol through a telephone number, text message, fingerprint, or other unique referencing identifiers or authentication protocols.

The consumer has the ability to control access to the identifying number with the desired methods of providing an accompanying identifying information. The consumer may provide settings for the availability of accessing the identifying number for the purposes of authentication. Settings may include number of accesses, time of access, address of location, entity permissions, rendezvous timing, recurring access, and/or desirable rules that customize the level of security of the identifying number for consumer. The consumer may be notified of a request for authentication through a digital interface, such as through a telephonic prompt, sms text, electronic mail, voice mail, or other alert or notification of a request to access private identity information.

The processor receives public and/or private identifying information from the consumer and/or a third party. The consumer provides the identifying information to the processor and/or data record. The consumer provides the identifying information from an interface that has connectivity through an internet, intranet, extranet, cloud, solid memory, chip, a physical input at a node, or a method of input that is non-electronic. Identifying information may be held in the data record with the identification number and reference number or may be held in another port of memory that is accessible to the processor or that the processor receives data from. The size of such memory may be from a bit or less, a chip card, an identification card, to macromemory devices such as a drive, shared resources, or to networked resourced such as a cloud. Information may be recorded and/or stored in any manner that allows a processor to receive the information or to request the information when queried to authenticate the identity of a consumer. Transmission of data to, from, with, accompanying, and between the processor and memory may be conducted in any desired protocol such as a secure channel, private-key encryption, integrated circuit, as well as non-electronic transmissions.

Financial services may proceed with and without a Social Security Number (SSN). A form for financial services includes identifying information of a consumer. A form requests information with an identifying number that authenticates without a SSN. The is stored in a memory device and retrievable through a memory processor. A request for authentication and financial service such as a loan is processed without the consumer providing the SSN on a form interface. A prior art form interface requires the consumer to provide the SSN in order to process a request for financial service.

The processor receives public and/or private identifying information for a consumer from a third party. The third party supplies the information or requests the information on behalf of the consumer. The consumer may provide a consent or an authorization for the authentication of identifying. The consumer may provide a static or dynamic reference code in order to authorize the authentication. The consumer may provide rules or settings in order to control access to the authentication protocol. The authentication may require input from the consumer in order to complete the authentication request. The processor receives or retrieves the components of the authentication request from the consumer and the third party. The processor then performs a process of authenticating the consumer's identity according to the data provided. The processor may be a crypto, secure, private, distributed, quantum, parcel, mapping, deconvoluting, or encrypted processor.

The third party may, for example, provide a physical address, telephonic address, name, and Zip code of the consumer. The consumer may be notified that the third party is requesting authentication. The processor retrieves data from one or more memory records with the identifying data, or has data supplied to it. Authentication of the identity is accomplished with data check, verification, deconvolution, or any practice of comparing the validity of and/or matching the value of data. The processor responds to a request to authenticate identity with binary response such as yes/no as well as a condition, status, request, bit, code, number, and/or provision of data. Responses may furthermore elicit additional requests and transmission of data.

The response of the processor to the authentication request provides a method for the system to respond to the authentication of a consumer identity in a multi-valent manner. Multi-valent responses allows the authentication to respond with confirmation of an identity, as well as more complex responses. Examples of the multi-valent responses that are complex encompass the likes of provisional authentication, authentication with indication, authentication with request, and/or a negatived authentication with one or more error codes. Error codes could indicate the kind of mismatch of data, missing data, suspicious data, and proprietary indicia. Furthermore, authentication responses, or their negatives, may additional accompany a payment increment, fee, toll, and/or token.

A third party may request various levels of authentication of information that may comprise a fee structure according to the level of detail. A third party could require: a surface match with regards to a social security reference that matches with address, a history match with regards the purchases and debts, a more extensive background check that cross-checks personal accounts with biographical details, or an exhaustive probe that exposits the results of a thorough examination of all of a consumer's personal and financial records. As such, the data record for a consumer may moreover comprise data for and/or access to public and private records that comprise financial attributes such as credit report, tax transcripts, court records, medical records, and/or any type of record that refers to, depends upon, references, or is linked to the identity of a person and/or entity. A third-party may also cause to have data transmitted to, with, preceding, or following an authentication request.

The practice of and service to the authentication of identity may be provided through computer or digital systems. Interfaces to the processor for a consumer may be an internee website, wireless connectivity, automated programming interface (API), automated clearninghouse, batch processes, secure sockets, direct coding, and/or software calls. The consumer may input data through a human-memory interface that is assisted through a node, terminal, website, and/or computer interface. The interface may include physical components that are transported or shipped to and from the consumer.

A physical interface may include a solidstate memory device that may be accessible only one time, a limited number of times, or unlimited number of times in order to record personal data of the consumer. Personal data may include social security numbers, account numbers, biometric data, and/or biographical information. A physical-digital interface may be provide to the consumer in order to input this data in an alphanumeric, digital, audio, electromagnetic, and/or frequentive input. The interface may be sent to and received from the consumer. The data from an interface may be recorded onto, into, through, and/or coded in a data memory record. The data record is accessible directly or indirectly to the processor. The memory device may comprise a processor that interfaces with the authentication request processor, or may be accessed through another processor that interprets between processors.

A data memory device may be inaccessible to a signal or caused to be inaccessible to an electronic signal. The processor that accesses a data memory device may be inaccessible to an electronic signal or caused to be inaccessible to an electronic signal. The processor that retrieves data from a data memory device may comprise a probe or sensor that transmits and/or receives a signal in an optical, wavelength, electromagnetic, molecular compound, combinatorial, thermal, and/or structural format. The data device receives and/or transmits a data signal in an optical, wavelength, electromagnetic, molecular compound, combinatorial, thermal, and/or structural format.

The memory device and/or the processor may receive an electronic signal and subsequently be rendered inaccessible to electronic signals. The memory device and/or the processor may receive an electronic signal and subsequently be rendered inaccessible to electronic signals. The memory device may be rendered inaccessible in order to protect the data from electronic reading and/or writing. The memory device may undergo transformation of physical, chemical, structural, crystallographic, electric, thermal, and/or phase states. Data may be stored, written, encoded, and/or incorporated in or with a physical, chemical, structural, crystallographic, electric, electronic, optical, thermal, and/or phase states of matter. The memory device and/or the processor may have been rendered inaccessible to electronic signals and rendered accessible. A device or processor may be rendered accessible or inaccessible through a physical, electromagnetic, interference, and/or thermal device or apparatus such as a shield or scrambler. A device or processor may be rendered accessible or inaccessible through a timing device, sensor, probe, radiation, thermal, and/or chemical sequence or combination of exposures.

The memory device communicates a signal to the processor with one or more of the methods accessible and/or transformational states. The memory device and processor may also communicate in electronic formats through cifer, interpreter, key, quanta, piranha, rubrix, shibboleth, signals, sublimate, tokens, and/or encrypted data. The processor may read, sense, determine, or register that a signal or state of the memory device. The memory device and processor may be programmed with rules regarding the accessibility of the data and/or device. Accessibility, signals, state, and/or rules are implemented in order to protect the integrity and security of the data. A routine or sequence of one or more of these signals, states, and/or rules may be programmed, calculated, determined, and/or handled in order to grant an access accessibility for the processor to retrieve data. Data is communicated in one or more of these methods to and from one or more memory devices and processors.

In order to authenticate the consumer data, a processor retrieves data from the memory device and receives consumer data from the authentication request. One or more processors conduct the operation of authenticating the consumer data. The processor responds with a determinate signal or status of the consumer identity. The processor may also respond in one or more of the confirmation or complex responses as defined above. The processor that retrieves data from the memory device may be a transmission chip or simple query device that responds with data in a format for a processor performing the authentication check. Separating the function of processors into low-level operations and data storage protects the integrity and security of consumer data. Implementing memory devices that respond in non-electronic ways provides degrees of separation that protect and secure data. The practice of performing authentication of consumer data using the memory devices that are accessible in non-electronic ways further protects the integrity and security of consumer data.

One preferred embodiment of the method protecting and securing data is the protection of credit card information during transactions. The data for financial transactions, for example, is moved from customer to business to credit card company to business to business transactions. With the use of the reference number, customers can be provided with new purchase and sales cards that allow the use of remote b2b transactions in order to process credit card purchase. Merchants and sellers would not need to store credit card information in order to process transactions. One or more reference numbers of the customers, in static and/or dynamic format, would allow a purchase card to process at a point of sale system and supply the needed information to approve a transaction without transmitting a credit card number from the point of sale device. A smartphone or electronic device with selectable accounts also may be used at a point of sale device. Rather, with the one or more reference numbers the purchase card provides the data that the point of sale device uses to process a transaction with a system having a processor that processes the transaction with a credit card company on behalf of the customer.

In the embodiment having the one or more reference numbers and a credit card. Processing of a transaction may proceed first with the method of authenticating identity as described above. Processing a transaction may proceed without a response for authenticating identity or with a multi-valent response as described above. In a portion of a data memory device, credit card numbers may be stored. The customer may have provided these numbers through a graphical user interface or a device that allows for inputting of account numbers. The consumer may select accounts for use with a purchase and/or at a point of sale. The consumer may use one card for purchase while drafting from one or more payment debit, credit, money, derivative, resource buffer, future, pool, donation, and/or bank accounts.

The consumer may also provide settings that automate the selection of one or more credit card accounts in order to process one or more transactions. Previous settings on the priority or preferential use of credit card accounts allows customers to preselect cards for specific uses, such as for food, groceries, fuel, utilities, exchanges, marketplaces, and/or bets. Selection of an account may activate the purchase card for use and/or configure a chip or stripe for use at a point of sale device. The purchase card may be a Smart Card that is programmable by the consumer or a third-party for use at a POS. The consumer can trace and track the details regarding third party requests for financial services such as with the time of request and type of financial service conducted. One or more reports or statements may generate or caused to be generated through any one or more contact, inquiry, request, transaction, notification, authorization, purchase, and/or sale. One or more consumers, entities, networks, systems, commissions, agencies, registers, logs, inquiries, officials, bots, persons, and/or transcripts receive/access to track and/or trace the one or more systems and/or practice that implement one or more financial services.

A purchase card may work on and/or with existing merchant accounts, automated clearinghouse, debit, automated teller machine, and/or credit card transaction systems. Arrangements and configurations may be used to transact purchases automatically and/or automated. Purchases may be initiated and/or transacted by or on behalf of one or more consumers and/or entities. Similarly sales may be conducted using a system as in a sales card rather than a purchase card. As such families may apportion budgetary monies towards accounts that are accessible by one or more persons. Business entities may provide a purchase and/or sales card in order to acquire and/or purchase of materials, goods, services, contracts, transactions, and/or exchanges. Consumers and/or entities may joint accounts with access to shared resources. An entity may cause one or more purchase and/or sales actions to occur and/or operate.

The arrangement of accounts, purchases, and/or sales may be done automatically, with triggers, timing, ranges, thresholds, notification, authorization, or any consumer or supplier control. The customer may also, or alternatively, use a programmable purchase card or purchase device that transmits with a reference number a code or selection of an account to use. A purchase card or device may comprise a chip, display, buttons, indicia, touch-screen and/or touch-sensitive areas that make selections at the time of purchase, at other desired times at the point of sale device, and/or by the customer. Similarly, the point of sale device may also be equipped with such features in order to process customer accounts and/or to process coupons and/or incentives of the retailer or seller. These selections at the point of sale device may be supplied at the time of sale in order to adjust prices. The use of a preferred embodiment of the system allows one or more consumers and/or entities to arrange and configure a customizable system/s and/or infrastructure's to conduct purchases and/or sales according to private means that are undetectable in public networks. Portions of a system may or may not contain private, personal, financial, and/or identity information on a public network, internee, intranet, extranet, and/or cloud.

A preferred embodiment serves financial decisions according to customer information and third-party data. Processing of a transaction may proceed first with the method of authenticating identity as described above. Processing a transaction may proceed without a response for authenticating identity or with a multi-valent response as described above. A third-party defines a procedure for making financial decisions that comprise one or more rules, programs, regulations, computations, formulas, criterions, and/or evaluations needed to respond to a request for and/or inquiry into a financial service such as auction, barter, credit, derivative, exchange, future, hedge, loan, purchase, refinance, increment, stock, bond, trade, grant, distribution, approval, conditional, request, substitution, transfer, liability, debt, collection, and/or sale of a monetary value. A system may be implemented in order to extend, expand, retract, cancel, and/or recall one or more financial services. Any entity that uses financial services may implement the process of rendering financial decisions. A purchase, sales, service, and/or transaction system may be implemented as a substitute to, competitive with, to supplement, advantageously position, to price, and/or perform auxiliary functions with one or more existing financial systems, exchanges, marketplaces, and/or networks. One or more procedures from one or more entities may be implemented to render one or more financial decisions for one or more customers and/or entities.

The entities may be actuarial, banking, government, revenue, insurance, medical, manufacturers, exchanges, marketplaces, consumer goods, and/or service companies or organizations that use or reference a Social Security Number and/or Employer Identification Number. The third-party requests the reference number of a customer and additional identifying features such as address and telephone number as defined above. The identifying information of the customer may be used to authenticate identity of a customer, entity, and/or a third-party. This request may be through a paper form, digital format, graphical interface, website, automated programming interface, audial format, keypad, telephonic format, and/or electronic input. Similarly the entity may define a procedure through one or more request formats for inputting a procedure. The procedure may translated into one or more program, script, interface, language, code, symbol, and encrypted formats. The procedure may be sent with requests or may be requested from another entity, customer, processor, and/or data memory. Procedures may be run in one or more automated form, batch, clearinghouse, register, and/or shell.

A processor retrieves a third-party procedure and a processor retrieves customer information. A processor processes the customer information according to the third-party procedure. The third-party procedure is implemented to apply custom defined logic to the data of the customer. The processor responds to the request for verification for financial attributes to the third-party. Specific financial data and/or identifying data may, or may not, be provided in the response from a processor to a third-party. The customer may or may not be notified of the request. The customer may or may not be prompted to grant permission to access identity and/or financial data. The customer may or may not have set financial data in a data memory record similar to the identifying information as discussed above. The customer may or may not be prompted about a conditional response that may or may not require permission about, a decision of a third-party procedure. The customer may or may not receive information about further actions to obtain a financial product from one or more third-parties. The customer may or may not receive advertisements from third-parties. Customer data and response may or may not be forwarded to one or more third-parties such as a financial services entity or marketplace. A customer, third-party, or entity processing the authentication and/or request may receive incentive, compensation, reward, credit, or commission for processing and/or completing a request.

The third-party procedure may be defined by the third-party, on behalf of a third-party, or for a third party. A procedure may be defined by one or more procedures from one or more Individuals, entities, organizations, and/or groups. A procedure defines a set of logical conditions comprising one or more rules, definitions, programs, regulations, computations, formulas, criterions, and/or evaluations needed to respond to a request for and/or inquiry into a financial service such as auction, barter, credit, derivative, exchange, future, hedge, loan, purchase, refinance, increment, stock, bond, trade, grant, distribution, approval, conditional, request, substitution, transfer, and/or sale of a monetary value. The procedure may be used to mask a financial service. The procedure may be used to conceal information about a customer and/or third-party from transmission relating to a financial service. A processor completes a procedure that may or may not result in a response. A processor completes a procedure that may or may not result a read, write, or update of data memory. The procedure may require additional steps or sequences, request information, exchange data, or obtain procedures in order to complete a request. The processor or procedure may respond with a multi-valent response. A multi-valent response may accompany an authentication of identity. A multi-valent response may further include one or more indication, condition, request for more information, time-sensitive response, offer, purchase, sale, instruction, recommendation, denial, transcript, title, lien, deed, bill, record, receipt, or statement.

A procedure defines a set of logical conditions that establish a way to evaluate a procedure or request. As genera, the procedure refers to identification and/or financial data, wherein a procedure requests at least one of these types of data in order to respond to a request. One of the purposes of the procedure is to define a procedure for the criterion to authenticate identity. For example, identity in a form may need to be authenticated according to a time, location, probability, and/or likelihood. Identity may also need to be authenticated using financial data such as tax records, credit card transactions, purchases, sales, and other kinds of transactions that indicate the time and location of a person. A procedure that authenticates identity furthermore responds with one or more responses that may or may not be in a multi-valent format. Procedures may be defined in a manner that is generic for computational and/or human methods of authenticating information depending on the level of sensitivity of the person and/or information. An automated system that operates the services may define procedures that third-parties may use. One or more procedures could define governmental regulations for conducting actuary, business, commerce, pricing, exchanges, transactions, transfers, purchases, sales, tax revenue, tariffs, risk, and/or loans. Or third-parties may define procedures that the service uses to provide customized authentication and/or responses. Procedures may be programmed with one or more flowcharts, process diagrams, scripts, programs, executibles, tags, codes, languages, assembly, in-chip, and/or on-chip implements. The procedure may be defined as a software program or in hardware circuits. A procedure may be performed by a processor in one or more local, distributed, remote, cloud, or server computers.

For financial services, the procedure encodes the logic used to determine financial decisions. A procedure automates the process of making financial decisions or decisions that use financial data. A customer application for a loan in one example of the procedure for authentication and response. A loan form routinely includes personal information including name and contact information. The form, however, may include an identifying number or reference for the customer that a procedure uses to authenticate the identity of the customer. Another procedure could operate to obtain the financial information of the customer. A procedure could respond with a query to the customer to supply current income, debt, and address. The procedure could automatically obtain this data from information provided by the customer. Another procedure could obtain the credit score and report on behalf of the customer and store the data in a memory device. Another procedure operates to process the financial information according to the evaluation process of the loan application. Procedures may automate any financial transaction wherein data may or may not be transmitted between a third party and services system. Procedures may be used to record information and/or to respond with business decisions.

A data input device allows a consumer to input identity information into one or more memory storage devices. Consumer inputs information through an input device such as a keyboard or keypad. A portion of the data is stored on a networked cloud and another portion on a memory device. The memory device may be inaccessible to another electronic device after storing the data. A consumer may update and/or modify information through an interface to the memory device or to a memory record in a remote location for processor procedures.

Data is accessed from a memory device with a memory process having connectivity to processors and a cloud. Data from a set of memory devices is retrieved by a memory processor. The memory devices operate with an accompanying sensor or supply device that responds to a request from the memory device to supply identifying data. The perforated lines represent accessible or inaccessible connectivity through an electronic signal. The memory processor sends an interrogative signal to the sensor to obtain data from the memory device. The memory processor provides data to one or more processors to authenticate the data or retrieve identifying data and/or financial attributes. The personal data is available only to the processors and for a certain amount of time. Personal data may not be stored on a processor or accessible to the cloud. The processor responds through a cloud interface to a request.

A flowchart for secure authentication of identifying data. A request for authentication accompanies personal identifying information. A request processor optionally uses the identifying information to notify a customer of a request for authentication. The dotted lines represent optional sequence or process flow. Notification may be sent through a sms text, email alert, telephonic interface, and/or automated preselected response. The request processor forwards the identifying information to a data processor. The customer responds to the notification of the request for authentication. The data processor obtains identifying number from the memory device if the customer approves the request. The data processor otherwise forwards the customer response to the authentication processor. The authentication processor authenticates the personal data from the memory device and the identifying data that accompanies the request for authentication if the customer approves the request. The authentication response provides the results of the authentication processor according to the identifying information provided in the request and the customer response to authentication notification.

A flowchart for secure authentication of identifying data and response to financial attribute service request. A request for authentication accompanies personal identifying information and a selection for a procedure to process financial attribute data. A request for financial service may be initiated with a form interface. A request processor optionally uses the identifying information to notify a customer of a request for authentication. The dotted lines represent optional sequence or process flow. Notification may be sent through a sms text, email alert, telephonic interface, and/or automated preselected response. The request processor forwards the identifying information to a data processor. The customer responds to the notification of the request for authentication. The data processor obtains identifying data and financial attributes from the memory device if the customer approves the request. The memory processor obtains the Social Security Number and using the identifying information obtains an identification number from the memory device. The memory processor obtains a financial attribute such as income level. The data processor otherwise forwards the customer response to the authentication processor. The authentication processor authenticates the personal data from the memory device and the identifying data and financial attributes if the customer approves the request. The authentication processor forwards the results of the authentication to the procedure processor.

The authentication response forwards the results and the procedure selection to the procedure processor. The procedure processor obtains the selected procedure logic. The procedure processor processes the financial attributes according to the logic of the procedure. Auxiliary processes may be used to obtain additional data or service, either remote or local, through a network or software. Additional data may be a supplemental information required to process the financial service. Additional service may be a request for Credit Report from a Credit Bureau. The procedure processor responds with an authentication response and a multi-valent response. The multi-valent response comprises an approval and a loan amount. The procedure processor provides the results of the authentication processor according to the identifying information provided in the request, the customer response to authentication notification, the identifying data, and the financial attributes.

A flowchart for a financial service request from a consumer at a Point of Sale. A flowchart for requesting a financial service at a POS. A request for authentication accompanies personal identifying information and a selection for an account from a purchase card to process purchase request. The consumer presets the accounts for selection through an input device and data input interface with connectivity to a cloud data record. A digital shopping cart, or store register, provides the currency amount to be purchased such as the amount in USD. A request processor optionally uses the identifying information to notify a customer of a request for authentication. The dotted lines represent optional sequence or process flow. Notification may be sent through a sms text, email alert, telephonic interface, and/or automated preselected response. The request processor forwards the identifying information to a data processor. The customer responds to the notification of the request for authentication. The data processor obtains identifying data and account number from the memory device if the customer approves the request. The data processor otherwise forwards the customer response to the authentication processor. The memory processor using the account selection obtains a credit card account number from a cloud memory and using the identifying information obtains an identification number from the memory device. The authentication processor authenticates the consumer data from the memory device and the identifying data and identification number and account number if the customer approves the request. The authentication processor forwards the results of the authentication to the procedure processor.

The authentication processor forwards the results and the account selection to the procedure processor. The procedure processor obtains the selected procedure logic. The procedure processor processes a financial transaction with the account number according to the logic of the procedure and purchase amount through a credit card network with connectivity through the auxiliary transactions. The procedure processor responds with an authentication response and a multi-valent response. The multi-valent response comprises a transaction number and timestamp. The procedure processor provides the results of the authentication processor as a multi-valent response according to the identifying information, the identification number, the customer response to authentication notification, the account selection, and the purchase amount.

A consumer purchase card having selectable features. The purchase card may be used at a point of sale device and processes the purchase through a procedure. The purchase card initiates the financial services request and sends identifying information to a request processor. The consumer may select a financial account from the purchase card. The account selection sets the microchip to provide the account selection and is programmed through the electronic connectivity from the selectable features to the microchip. The purchase card is inserted into a Point of Sale system that reads the microchip. The request for financial service of a purchase is transmitted to a request processor. The account is sent with the request along with the identifying information. A purchase transaction using a credit card account is processed through the procedure processor. The request receives a multi-valent response of authentication and completion of purchase transaction.

### FIGURES

The following are discussions of the Figures for certain preferred embodiments.

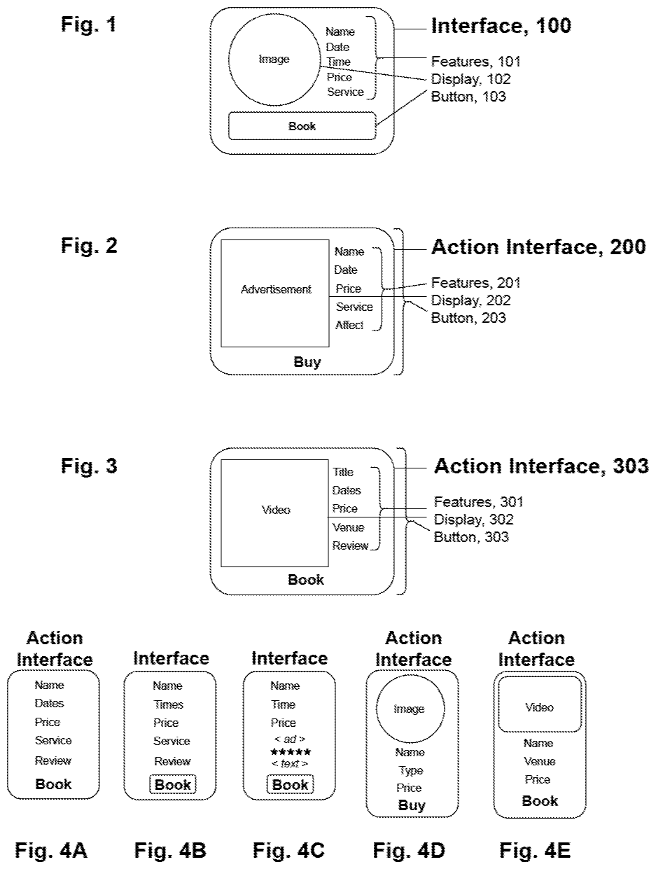

FIG. 1. is an electronic interface, 100, comprising features, 101, a display, 102, and a button, 103. The features include in this example a name, date, time, price, and description of service. My combination of features may be displayed in desired arrangements, shapes, and sizes. The button is an example of an action interface.

FIG. 2. is an electronic action interface, 200, comprising features, 201, a display, 202, and a button, 203. The features include in this example a name, date, price, description of service, and affect. The display is an advertisement. Any combination of display and features may be presented in desired arrangements, shapes, and sizes. The entire area of the action interface, or portions thereof, is responsive as a button to clicks.

FIG. 3. is an electronic action interface, 300, comprising features, 301, a display, 302, and a button, 303. The features include in this example a name, date, price, venue, and affect. Any combination of features may be displayed in desired arrangements, shapes, and sizes. The entire area of the action interface, or portions thereof, is responsive as a button to clicks.

FIGS. 4A-4E. are electronic interfaces and action interfaces comprising arrangements of features, displays, visuals, and action interfaces. The interfaces may comprise action interfaces such as a button, for example, or be an action interface that is responsive to commands or for example as a button. Any combination of display and features may be presented in desired arrangements, shapes, and sizes. The entire area of the action interface, or portions thereof, is responsive as a button to clicks.

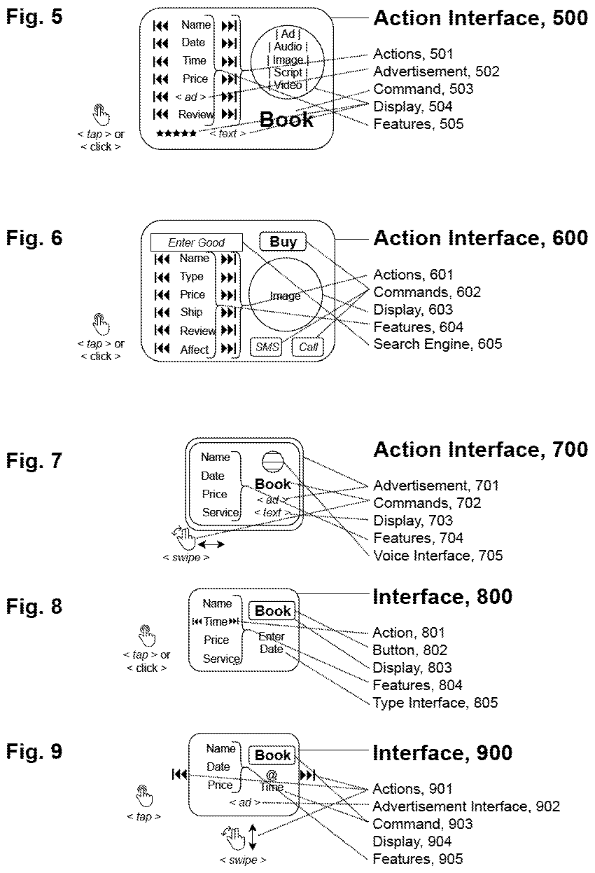

FIG. 5. is an electronic action interface, 500, comprising actions, 501, advertisement, 502, command, 503, display, 504, and features, 505. Actions are presented that allow a person or electronic method to select the next or previous record for a feature. An advertisement is presented as type or visual. A command allows a person or electronic to perform an action such as to book an appointment time. The features include in this example a name, date, time, price, and review. The display comprises a visual. A visual and type are displayed that correspond with a review, either as text from the review, affect associated with the review, or combinations thereof. A command pertains to one or more person or electronic ways to interact with, refer to, search for, purchase, request, retrieve, and response may be displayed. Any kind, number, and combinations of actions, display, type, and features may be presented in desired arrangements, shapes, and sizes. The entire area of the action interface, actions, or portions thereof, is responsive e.g. as to a command, as a button to clicks, and combinations thereof.

FIG. 6. is an electronic action interface, 600, comprising actions, 601, command, 602, display, 603, features, 604, and search, 605. Actions refers to displays presented that allow a person or electronic to select the next or previous record for a feature. A command allows a person or electronic to perform an action such as send a sms text or VoIP call to a business. The display comprises a visual and could be an advertisement. The features include in this example a name, type, price, shipment method designated by the type display “ship,” review, and affect. A command pertains to one or more person or electronic ways to interact with, refer to, search for, purchase, request, retrieve, and response may be displayed. Any kind, number, and combinations of actions, display, type, and features may be presented in desired arrangements, shapes, and sizes. The entire area of the action interface, actions, or portions thereof, is responsive e.g. as to a command, as a buy button to click, and combinations thereof.

FIG. 7. is an electronic action interface, 700, that is presented as an advertisement, 701, and comprises a command, 702, display, 702, features, 704, and voice interface, 705. An advertisement is presented as one or more of display, type, visual, and combinations thereof. A command allows a person or electronic to perform an action such as swipe the advertisement in order to display the next advertisement. A command allows a person or electronic to perform a command such as to book a service time with, for example, a click of the interface, a button, or a spoken command. A command pertains to one or more person or electronic ways to interact with, refer to, search for, purchase, request, retrieve, and response may be displayed. The features include in this example a name, date, price, and service name. An interface is responsive to voice searches, requests, and commands. Any kind, number, and combinations of actions, display, type, and features may be presented in desired arrangements, shapes, and sizes. The entire area of the action interface, actions, or portions thereof, is responsive e.g. as to a command, as a button to clicks, and combinations thereof.

FIG. 8. is an electronic interface, 800, comprising an action, 801, button, 802, display, 803, features, 804, and type interface, 805. Actions refers to displays presented that allow a person or electronic to select the next or previous record for a feature. The button is an example of an action interface that is responsive to commands. The action interface may be displayed as a result of a command or action to locate, search, respond, retrieve, present, select, specify and display, records that pertain to a booking or schedule. For example, a record that pertains to an appointment may comprise a command such as book. Commands may further include those of a person or a known electronic way to search for and revise an appointment. Another example may be command that pertain to a good, product, or ticket.

A command pertains to one or more person or electronic ways to interact with, refer to, search for, purchase, request, retrieve, and response may be displayed. A command may specify the instruction in one or more of a type, audible, visual form, and combinations thereof. Features include name, time, price, and type reference to a service. A type interface is responsive to a command that presents type. This type data may be used by a person or in an electronic to locate, search, respond, retrieve, present, select, specify and display, records that pertain to a booking or schedule. My kind, number, and combinations of actions, display, type, and features may be presented in desired arrangements, shapes, and sizes. The entire area of the action interface, actions, or portions thereof, is responsive e.g. as to a command, as a button to clicks, and combinations thereof.

FIG. 9. is an electronic interface, 900, comprising an action, 901, advertisement, 902, command, 903, display, 904, and features, 905. Actions refers to displays presented that allow a person or electronic to select with a tap the next or previous instance within a record. Actions refers to displays presented that allow a person or electronic to select with a swipe the next or previous record. The button is an example of an action interface that is responsive to commands. The action interface may be displayed as a result of a command or action to locate, search, respond, retrieve, present, select, specify and display, records that pertain to a booking or schedule. For example, a record that pertains to a daytime booking may comprise a command such as book and receive further instructions as to a time.

A command may specify the instruction in one or more of a type, audible, visual form, and combinations thereof. A command pertains to one or more person or electronic ways to interact with, refer to, search for, purchase, request, retrieve, and response may be displayed. Another example may be command that pertain to a good, product, or ticket. The display may pertain to the electronic records in or of a schedule including or more more of and not limited to a date, price, time, location, and combinations thereof. Electronic commands pertain to one or more of a person or electronic to interact with, refer to, search for, purchase, request, retrieve, and response may be displayed.

A type interface is responsive to a typed input or audible command to specify type information. Features include name, time, price, and type reference to a service. This type data may be used by a person or in an electronic to locate, search, respond, retrieve, present, select, specify and display, records that pertain to a booking or schedule. Any kind, number, and combinations of actions, display, type, and features may be presented in desired arrangements, shapes, and sizes. The entire area of the action interface, actions, or portions thereof, is responsive e.g. as to a command, as a button to clicks, and combinations thereof.

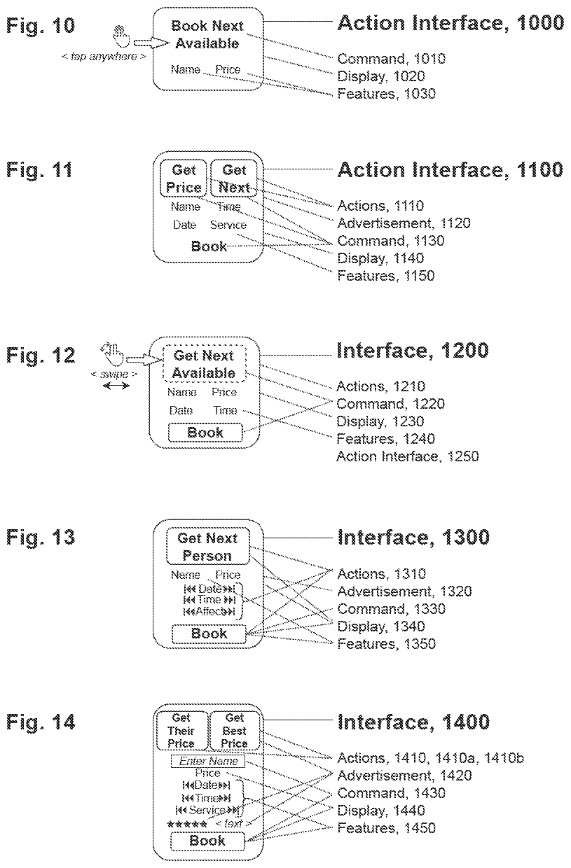

FIG. 10. is an electronic action interface, 1000, comprising a command, 1010, display, 1020, and features, 1030. The interface is responsive to one or more actions that pertain to one or more commands. Actions are presented that allow a person or electronic provide an instruction to the electronic such as to book the next available appointment by speaking the phrase “book next available.” The action interface may be displayed as a result of a command or action to locate, search, respond, retrieve, present, select, specify and display, records that pertain to a booking or schedule. For example, a record that pertains to a daytime booking may comprise a command such as book and receive further instructions as to a time.

A command may specify the instruction in one or more of a type, audible, visual form, and combinations thereof. A command pertains to one or more person or electronic ways to interact with, refer to, search for, purchase, request, retrieve, and respond may be displayed. Another example may be command that pertain to a good, product, or ticket. The display may pertain to the electronic records in or of a schedule including or more more of and not limited to a date, price, time, location, and combinations thereof. Electronic commands pertain to one or more of a person or electronic to interact with, refer to, search for, purchase, request, retrieve, and response may be displayed.

The display is an interface that is responsive to one or more of type, audible, or visual command to specify data. Features include in this embodiment for example name and price. This data may be used by a person or in an electronic to locate, search, respond, retrieve, present, select, specify and display, records that pertain to a booking or schedule. My kind, number, and combinations of actions, display, type, and features may be presented in desired arrangements, shapes, and sizes. The entire area of the action interface, actions, or portions thereof, is responsive e.g. as to a command, as a button to clicks, and combinations thereof.

FIG. 11. is an electronic action interface, 1100, comprising action, 1110, advertisement, 1120, command, 1130, display, 1140, and features, 1150. The interface is responsive to one or more actions that pertain to one or more commands. Actions are presented that allow a person or electronic provide an instruction to the electronic such as get a price by speaking the phrase “get price” or get the next appointment by speaking the phrase “get next.” The actions may be displayed as a result of a command or action to locate, search, respond, retrieve, present, select, specify and display, records that pertain to a booking or schedule. For example, a record that pertains to a daytime booking may comprise a command such as book and receive further data including for example a price.

Displays may be used by a person or electronic to analyze or compare data. The actions may be both action interfaces that are responsive to a command and representative for a display. A display may comprise an advertisement, type, visual, and combinations thereof. Advertisements also may be presented as a result of one or more of and not limited to records pertaining to a schedule, to commands, affects, and combinations thereof.

A command may specify the instruction in one or more of a type, audible, visual form, and combinations thereof. A command pertains to one or more person or electronic ways to interact with, refer to, search for, book, buy, purchase, request, retrieve, and response may be displayed. Another example may be command that pertain to booking an appointment or nightly reservation. The display may pertain to the electronic records in or of a schedule including or more more of and not limited to a date, price, time, location, and combinations thereof. Electronic commands pertain to one or more of a person or electronic to interact with, refer to, search for, purchase, request, retrieve, and response may be displayed.

Features include in this embodiment for example name, price, date, and type of service. The display is interface that is responsive to one or more of type, audible, or visual command to specify data. This data may be used by a person or in an electronic to locate, search, respond, retrieve, present, select, specify and display, records that pertain to a booking or schedule. Any kind, number, and combinations of actions, display, type, and features may be presented in desired arrangements, shapes, and sizes. The entire area of the action interface, actions, or portions thereof, is responsive e.g. as to a command, as a button to clicks, and combinations thereof.

FIG. 12. is an electronic interface, 1200, comprising actions, 1210, command, 1220, display, 1230, features, 1240, and an action interface, 1250. The interface is a display of one or more of audibles, commands, types, visuals, and combinations thereof. Actions are presented that allow a person or electronic provide an instruction to the electronic such as get the next available time by speaking the phrase “get next available.” The actions may be displayed as a result of a command or action to locate, search, respond, retrieve, present, select, specify and display, records that pertain to a booking, data, record, schedule, and combinations thereof. For example, a record that pertains to a daytime booking may comprise a command such as get booking availability and receive further data including for example a time or price. The actions may be both action interfaces that are responsive to a command and representative for a display. A display may comprise an advertisement, type, visual, and combinations thereof. Advertisements also may be presented as a result of one or more of and not limited to records pertaining to a schedule, to commands, affects, and combinations thereof.

A command may specify the instruction in one or more of a type, audible, visual form, and combinations thereof. A command pertains to one or more person or electronic ways to interact with, refer to, search for, book, buy, purchase, request, retrieve, and respond may be displayed. Another example may be command that pertain to booking an appointment or nightly reservation. The display may pertain to the electronic records in or of a schedule including or more more of and not limited to a date, price, time, location, and combinations thereof. Electronic commands pertain to one or more of a person or electronic to interact with, refer to, search for, purchase, request, retrieve, response, and combinations thereof may be displayed. Features include in this embodiment for example name, price, date, and time of service. The display is interface that is responsive to one or more of type, audible, or visual command to specify data. This data may be used by a person or in an electronic to locate, search, respond, retrieve, present, select, specify and display, records that pertain to a booking or schedule. Any kind, number, and combinations of actions, display, type, and features may be presented in desired arrangements, shapes, and sizes. The entire area of the action interface, actions, or portions thereof, is responsive e.g. as to a command, as a button to clicks and swipe to display.

An action interface displays a command or action to locate, search, respond, retrieve, present, select, specify and display, records that pertain to a booking or schedule. For example, a record that pertains to a daytime booking may comprise a command such as book and receive further instructions as to a time. An action interface is responsive to an action one or more of a swipe-up, a swipe-down, swipe-right, swipe-left, swipe-diagonals up, swipe-diagonals down, swipe geometric shape, sign, signed finger, and hand gesture to display a new record such as a month, week, time of day, person, event, and activity. One or more haptics may allow a person or electronic to interact with or navigate a record for desired or convenient effect.

FIG. 13. is an electronic interface, 1100, comprising action, 1110, advertisement, 1120, command, 1130, display, 1140, and features, 1150. The interface is responsive to one or more actions that pertain to one or more commands. Actions are presented that allow a person or electronic provide an instruction to the electronic such as get the next person who does a service by speaking the phrase “get next person.” The actions may be displayed as a result of a command or action to, locate, search, respond, retrieve, present, select, specify and, display, records that pertain to a booking, data, record, schedule, and combinations thereof. For example, a record that pertains to a daytime booking may comprise a command such as book and receive further data including for example a price.

Displays may be used by a person or electronic to analyze or compare data. The actions may be both action interfaces that are responsive to a command and representative for a display. Actions may be used to do one or more of go to the next record of a feature, such as the next person, another price, a different date, an available time, a representative affect of interest to a person or electronic, and combinations thereof. A display may comprise an advertisement, type, visual, and combinations thereof. Advertisements also may be presented as a result of one or more of and not limited to records pertaining to a schedule, to commands, affects, and combinations thereof.

A command may specify the instruction in one or more of a type, audible, visual form, and combinations thereof. A command pertains to one or more person or electronic ways to interact with, refer to, search for, book, buy, purchase, request, retrieve, and response may be displayed. Another example may be command that pertain to booking an appointment or nightly reservation. The display may pertain to the electronic records in or of a schedule including or more more of and not limited to a date, price, time, location, and combinations thereof. Electronic commands pertain to one or more of a person or electronic to interact with, refer to, search for, purchase, request, retrieve, and response may be displayed.

The display is interface that is responsive to one or more of type, audible, or visual command to specify data. Features include in this embodiment for example name, price, date, time, and affect. This data may be used by a person or in an electronic to locate, search, respond, retrieve, present, select, specify and display, records that pertain to a booking or schedule. Any kind, number, and combinations of actions, display, type, and features may be presented in desired arrangements, shapes, and sizes.

FIG. 14. is an electronic interface, 1400, comprising action, 1410, advertisement, 1420, command, 1430, display, 1440, and features, 1450. The interface is responsive to one or more actions that pertain to one or more commands. Actions are presented that allow a person or electronic provide an instruction to the electronic such as get a price by speaking the phrase “get price” or get the next appointment by speaking the phrase “get next.”

The actions may be displayed as a result of a command or action to locate, search, respond, retrieve, present, select, specify and display, records that pertain to a booking, data, record, schedule, and combinations thereof. For example, a record that pertains to a daytime booking may comprise a command such as book and receive further data including for example a price. Actions may be used to do one or more of go to the next record of a feature, such as the next date, an available time, service offered, and combinations thereof.

Displays present to a person or electronic data to analyze or compare such as bookable prices, 1410a and 1410b, or one or more of and not limited to advertisements, schedules, booking data, records, persons, and combinations thereof. The actions may be both action interfaces that are responsive to a command and representative for a display. A display may comprise an advertisement, type, visual, review, and combinations thereof. Advertisements also may be presented as a result of one or more of and not limited to records pertaining to a schedule, to commands, affects, and combinations thereof.

A command may specify the instruction in one or more of a type, audible, visual form, and combinations thereof. A command pertains to one or more person or electronic ways to interact with, refer to, search for a person or product, book, buy, request, retrieve, and response may be displayed. Another example may be command that pertain to booking an appointment or nightly reservation. The display may pertain to the electronic records in or of a schedule including or more more of and not limited to a date, price, time, location, and combinations thereof. Electronic commands pertain to one or more of a person or electronic to interact with, refer to, search for, purchase, request, retrieve, and response may be displayed.

Features include in this embodiment for example name, price, date, and type of service. The display is interface that is responsive to one or more of type, audible, or visual command to specify data. This data may be used by a person or in an electronic to locate, search, respond, retrieve, present, select, specify and display, records that pertain to a booking or schedule. Any kind, number, and combinations of actions, display, type, and features may be presented in desired arrangements, shapes, and sizes. The areas of the action interface, actions, or portions thereof, is responsive e.g. as to a command, as a button to clicks, and combinations thereof.

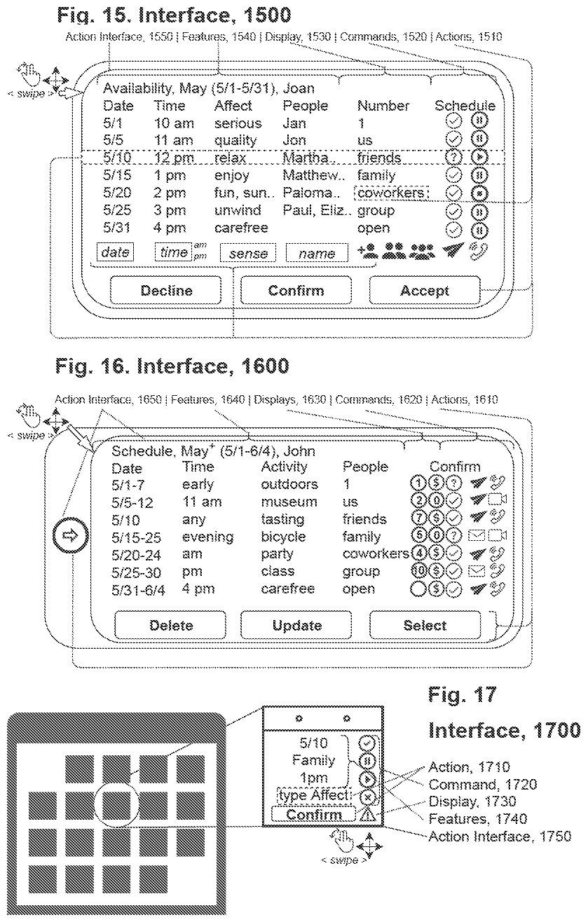

FIG. 15 is an electronic interface, 1500, comprising action, 1510, commands, 1520, display, 1530, features, 1540, and action interface, 1550. The interface is responsive to one or more actions that pertain to one or more commands. An action interface is responsive to an action such as a swipe-up, a swipe-down, swipe-right, or swipe-left, that displays a new record such as a month, week, time of day, person, event, and activity. One or more haptics may allow a person or electronic to interact with or navigate a record for a desired or convenient effect.

Actions are presented that allow a person or electronic provide an instruction to the electronic such as get an appointment record or a booking record. Actions further allow a person or program to navigate among actions interfaces, features, displays, commands, and actions on the electronic interface. Actions include, for example, and not limited to: accept an event, confirm a record, decline a booking, or delete a person from a schedule, for example. Actions also include select a row or a cell in order to modify the record with a command. Actions include rows comprising text and search interfaces that allow a person or electronic to add or modify records that pertain to features. The actions may be displayed as a result of a command or action to locate, search, respond, retrieve, present, select, specify and display, records that pertain to a booking, data, record, schedule, and combinations thereof. For example, a record that pertains to a daytime booking may comprise a command such as book and receive further data including for example a price.

Actions may be used to do one or more of go to the next record of a feature, add a person, subtract a person, enter a date, time, desired affect, and a name. The actions may be both action interfaces that are responsive to a command and representative for a display. Actions may specify portions of the record, all or in part, including for example next date, pricing, an available time, service offered, and combinations thereof.

Actions may specify polymorphic action areas or buttons that display data pertaining to a record. Polymorphic actions may change one or more of and is not limited to a shape, size, color, shade, hue, hash, grey, opacity, visibility, visual, feature, display, and action interface in response to one or more and and not limited to an action, event, click, swipe, and tap.

Features include in this embodiment for example name, date, time, and type of service. Features pertain to the data in a record that may be specified by a person or electronic. Features may be searched, selected, retrieved, stored, saved, refreshed, and modified.

Displays present to a person or electronic data to analyze or compare such as one or more of and not limited to advertisements, schedules, booking data, records, persons, and combinations thereof. The display is interface that is responsive to one or more of type, audible, or visual command to specify data. This data may be used by a person or in an electronic to locate, search, respond, retrieve, present, select, specify and display, records that pertain to a booking or schedule. Any kind, number, and combinations of actions, display, type, and features may be presented in desired arrangements, shapes, and sizes. A display may at least in part comprise an advertisement, type, visual, review, and combinations thereof. Advertisements also may be presented as a result of one or more of and not limited to records pertaining to a schedule, to commands, affects, and combinations thereof.

A command may specify the instruction in one or more of a type, audible, visual form, and combinations thereof. A command pertains to one or more person or electronic ways to interact with, refer to, search for a person or product, book, buy, request, retrieve, and response may be displayed. Another example may be command that pertain to booking an appointment or nightly reservation. Electronic commands pertain to one or more of a person or electronic to interact with, refer to, search for, purchase, request, retrieve, and response may be displayed. A command includes and is not limited to accept, confirm, decline, play, go, stop, pause, and search. A command may generate or cause to do one or more of and not limited to an action, a sms text, place a telephone call, and an API call, for example. The result of a command may have an effect on a record include one or more of and not limited to revising, adding to, scheduling, deleting, removing, confirming, cancelling, and rescheduling a feature of a record.

Commands may generate an action to do one or more of and not limited to navigate between records, to send notification of an action, to cause a revision of a record, request confirmation, retrieve a schedule, and set a new record. A check mark button may designate, display, or refer to a confirmed record. A play button may designate, display, refer to, require, retrieve, or request a confirmation for a record. A question mark may designate an indeterminate data of a record such as, for example, time, status as confirmed, status as declined, or unconfirmed. A pause may for example place a hold on a record or display a record as waiting. A stop may unschedule, unconfirm, cancel, or stop payment on a record.

FIG. 16 is an electronic interface, 1600, comprising action, 1610, commands, 1620, display, 1630, features, 1640, and action interfaces, 1650. The interface is responsive to one or more actions that pertain to one or more commands. An action interface is responsive to an action such as a swipe-up, a swipe-down, swipe-right, or swipe-left, that displays a new record such as a month, week, time of day, person, event, and activity. The arrow may be response to a slide or tap in order to select a row. A display action interface may be response to a sliding up or sliding down to automatically select the middle rows. One or more haptics may allow a person or electronic to interact with or navigate a record for a desired or convenient effect.

Actions are presented that allow a person or electronic provide an instruction to the electronic such as get an appointment record or a booking record. Actions further allow a person or program to navigate among actions interfaces, features, displays, commands, and actions on the electronic interface. Actions include, for example, and not limited to: delete a portion of a record, update a record, or select a record. Actions also include select a row or a cell in order to modify the record with a command. Actions include rows comprising text and search interfaces that allow a person or electronic to add or modify records that pertain to features. The actions may be displayed as a result of a command or action to locate, search, respond, retrieve, present, select, specify and display, records that pertain to a booking, data, record, schedule, and combinations thereof. For example, a record that pertains to a daytime booking may comprise a command such as a watch in order to automatically book a time with a designated person for a bookable time, bookable day, or for a bookable range of prices.

Actions may be used to do one or more of go to the next record of a feature, add a person, subtract a person, enter a date, time, desired affect, and a name. The actions may be both action interfaces that are responsive to a command and representative for a display. Actions may specify portions of the record, all or in part, including for example next date, pricing, an available time, service offered, and combinations thereof.

Actions may specify polymorphic action areas or buttons that display data pertaining to a record. Polymorphic actions may change one or more of and is not limited to a shape, size, color, shade, hue, hash, grey, opacity, visibility, visual, feature, display, and action interface in response to one or more and and not limited to an action, event, click, swipe, and tap.

Features include in this embodiment for example name, date, time, and type of service. Features pertain to the data in a record that may be specified by a person or electronic. Features may be searched, selected, retrieved, stored, saved, refreshed, and modified.

Displays present to a person or electronic data to analyze or compare such as one or more of and not limited to advertisements, schedules, booking data, records, persons, and combinations thereof. The display is interface that is responsive to one or more of type, audible, or visual command to specify data. This data may be used by a person or in an electronic to locate, search, respond, retrieve, present, select, specify and display, records that pertain to a booking or schedule. Any kind, number, and combinations of actions, display, type, and features may be presented in desired arrangements, shapes, and sizes. A display may at least in part comprise an advertisement, type, visual, review, and combinations thereof. Advertisements also may be presented as a result of one or more of and not limited to records pertaining to a schedule, to commands, affects, and combinations thereof. A display may include one or more of a display or polymorphic action for the number of people attending an activity in numeral form, that a price was paid for an activity by reference to a currency symbol, that zero price was paid for an activity the price paid for an activity, and any set or unset data pertaining to a record.

A command may specify the instruction in one or more of a type, audible, visual form, and combinations thereof. A command pertains to one or more person or electronic ways to interact with, refer to, search for a person or product, book, buy, request, retrieve, and response may be displayed. Another example may be command that pertain to booking an appointment or nightly reservation. Electronic commands pertain to one or more of a person or electronic to interact with, refer to, search for, purchase, request, retrieve, and response may be displayed.

A command includes and is not limited to accept, confirm, decline, play, go, stop, pause, and search. A command may generate or cause to do one or more of and not limited to an action, a sms text, place a video call, an augmented reality call, make a virtual reality address available, enter into a virtual reality space, a holographic call, send an email, place a telephone call, and an API call, for example, and combinations thereof. The result of a command may have an effect on a record include one or more of and not limited to revising, adding to, scheduling, deleting, removing, confirming, cancelling, and rescheduling a feature of a record.

Commands may generate an action to do one or more of and not limited to navigate between records, to send notification of an action, to cause a revision of a record, request confirmation, retrieve a schedule, and set a new record. A check mark button may designate, display, or refer to a confirmed record. A play button may designate, display, refer to, require, retrieve, or request a confirmation for a record. A question mark may designate an indeterminate data of a record such as, for example, time, status as confirmed, status as declined, or unconfirmed. An exclamation mark may display information such as a schedule conflict or double-booking. A pause may for example place a hold on a record or display a record as waiting. A stop may unschedule, unconfirm, cancel, or stop payment on a record.

FIG. 17 is an electronic interface, 1700, comprising action. 1710, commands, 1720, display, 1730, features, 1740, and action interface, 1750 with functionality as in FIGS. 5-9 and 15-16. The interface in this embodiment pertains to an interface from a electronic calendar display. Calendar interfaces may appear within a calendar program, interact with a calendar program, and combinations thereof. Actions may access one or more calendars, retrieve one or more calendars, search one or more calendars for data, synch one or more calendar data, and cause revisions to one or more calendars, and combinations thereof.

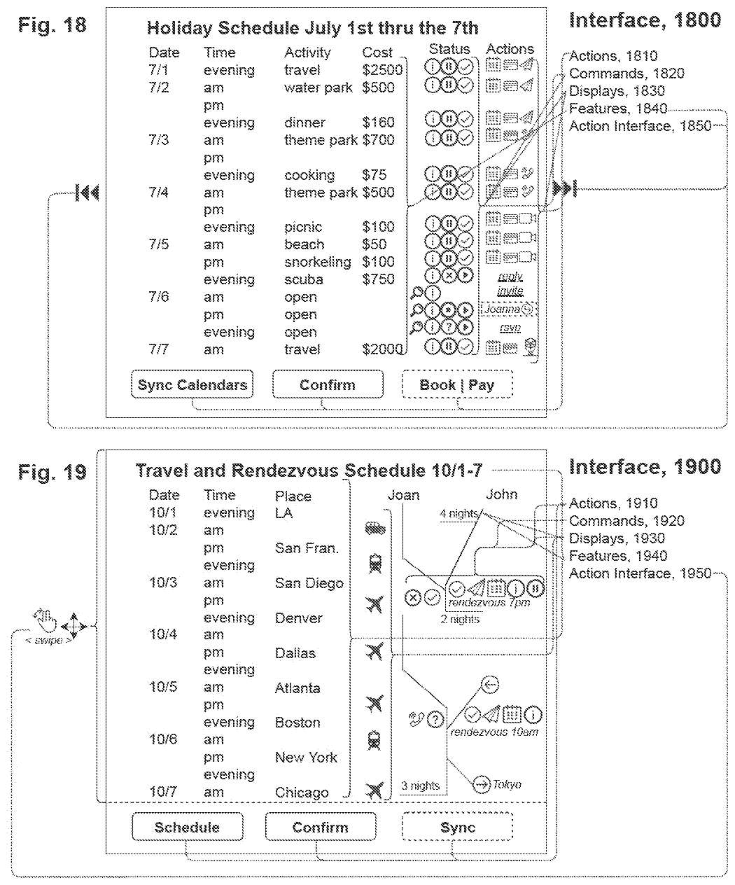

FIGS. 18-19 are electronic interfaces, 1800|1900, comprising actions, 1810|1910, commands, 1820|1920, displays, 1830|1930, features, 1840|1940, and action interfaces, 1850|1950. The interfaces further comprise one or more functionalities as in FIGS. 1-17, portions thereof, layouts thereof, combinations thereof, and not limited thereby. The interface in this embodiment pertains to an interface from a electronic calendar display. Interfaces may also include displays that link to visuals that comprise hypertext, structured query language script, programming script, or javascript method. Visuals may comprise one or more of and is not limited to data and commands pertaining to actions, records, calendars, schedules, reservations, schedulable, bookable, scheduled, booked, payable, paid, advertised data, portions thereof, and combinations thereof. Searching actions display for example by and not limited to a magnifying visual or type box having a search or enter visual display, as shown.

Actions may furthermore pertain to any known way to refer to electronic, digital, and internet communications as well as known phrases in any language, gesture, form, sign, or symbol referring to scheduling and booking functionality, such as, for example, and not limited to reply, confirm, pay, book now, invite, and rsvp. Commands display visual forms of actions and action interfaces. Polymorphic action areas such as buttons may be used to display actions or commands that pertain to scheduling or revising a record. The actions areas may furthermore display one or more in a series of actions or commands that schedule or revise a record. Records pertain to those that are schedules, calendars, reservations, schedulable, bookable, scheduled, booked, payable, paid, advertised data, portions thereof, and combinations thereof.

Displays may furthermore pertain to visual representation of record data. For example, visual icons for planes, trains, and automobiles may each refer to existing travel records such as booked tickets, reservations, or modes of transportation. Displays include one or more of and not limited to any known visual, icon, emoji, symbol, or display that refers to or represent a schedulable, bookable, scheduled, booked, payable, paid, and advertised record. A record could furthermore include a query, reservation, search, profile, portion thereof, and combinations thereof. Further, type and visuals may represent data that refers to data of, among, and between records. Represented data, shown here as lines and patterns, refers to the portions of the itinerary in reference to one or more persons. The interfaces may have action interfaces that allow a person, or electronic, to navigate to one or more of and not limited to additional records, reservations, schedules, itineraries, persons, places, and combinations thereof.

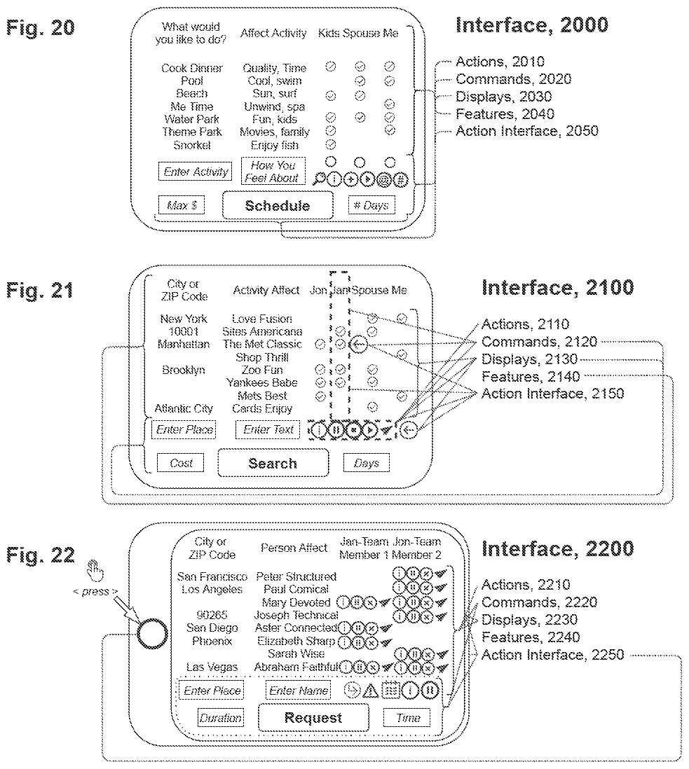

FIGS. 20-22 are electronic interfaces, 2000|2100|2200, comprising actions, 2010|2110|2210, commands, 2020|2120|2220, displays, 2030|2130|2230, features, 2040|2140|2240, and action interfaces, 2050|2150|2250. The interfaces further comprise one or more functionalities as in FIGS. 1-19, portions thereof, layouts thereof, combinations thereof, and not limited thereby. The interfaces in this display pertain to schedules that pertain to activities, affect, people, places, cost, and time. In addition to aforementioned interfaces, in the FIG. 20 embodiment, select actions, commands, displays, and action interfaces coincide. A person or electronic may interact with the interface in order to schedule desire activities. The schedule allows a person or electronic to set rules according to activity, affect, people, place, cost, and time. For example, text pertaining to activity is entered, which may be auto-filled with categorized activities. A cost is set, affect, activity attribute, and a number of days. One or more persons are selected pertaining to features of a group such as the persons participating in an itinerary. The interface pertains to a view of adding a scheduled activity to an itinerary.

Record Representations include an information-button (i-encircle) may respond to click, tap, and/or voice command with a form and/or script that allows a person or electronic to input data about an activity. Next, a new participant may be added with a form and/or script that allows a person or electronic to add a person's name whom to add to the itinerary for the activity. A plus-button (+-encircle) may respond to a click, tap, and/or voice command with a form and/or script that allows a person or electronic to input data. An activity may be added on behalf of participants by selecting an open circle to designate one or more additional participants. A play-button (righthand triangle-encircle) may respond to a click, tap, and/or voice command with a form and/or script that allows a person or electronic to store an activity record in an itinerary. A name, reference to, or data for an activity may be entered in a text box and the information sent to a search engine or scheduling engine for a categorized activity. A magnifying glass may respond with a form and/or script to a key command, click, tap, and/or voice command for a person or electronic to search for a type activity.

Record Representations include a new participant or participants may be invited to the activity. An at-button (@-encircle) may respond with a form and/or script that allows a person or electronic to add a person's name to whom a scheduling engine sends an invitation. An invited participant as a person may then accept or decline an invitation for an event, an invited participant may have an electronic accept or decline an invitation for an event based on one or more rules such as and not limited by cost, time conflict, and/or place limitation based on one or more relations such as and not limited by incompatible affect, activity purpose, and/or named persons. The at-button is an example of applying having rules or relations that are set by other people or electronics impact a schedule of a person sending, for example, an invitation..

Record Representations include a media posting may be preset, or added, to an activity so that a posting appears on a social network or social media website. A hashtag-button (#-encircle) may respond with a form and/or script to a command, click, tap, and/or voice command in order to schedule a media posting and associated with a profile of a person or electronic for whom the itinerary is prepared or displayed. The media posting may be transmitted to one or more of any networked device, software, or platform such as for example and not limited to a social media platform such as TWITTER, a social network such as INSTAGRAM, and a social interest platform such as PINTEREST. Further, media postings may be scheduled and transmitted or posted on behalf of participants in the activity through a scheduling engine. Posting rules and relations may be defined by one or more of and not limited to a scheduling engine, booking engine, social network, social media platform, profile for a participant, and combinations thereof.

FIG. 21 is an interface that comprises action interface selectors that allow a person or electronic to select, for example, a column that pertains to a person in a schedule group. The selector also allows a person to select a row, for example. In this case, the person Jan is selected and the activity for The Met is selected (lefthand-arrow-encircle). The action interface allows a person or electronic then to revise the activity record for Jan. The action interface provides a form or script pertaining to one or more of information (i-encircle), pause a reservation (bar-bar-encircle), cancel the reservation (square-encircle), reconfirm a reservation (righthand-triangle-encircle), send a sms message Jan (paper-airplane-icon), update the text of the activity including and not limited to place and affect (text fields), save revisions (lefthand-arrow-encircle), and to select or deselect a person's participation in an activity (checkmark-encircle). Action interfaces allow a person or electronic revise a record that pertains for example to a scheduled activity. The interface allows a person or electronic to conveniently manage communication and detail for persons of an activity in an easy-to-use vie.

FIG. 22. is an interface that in addition to features of FIG. 21 provides individualized actions that comprise commands and action interfaces for each person according to the activity. More detailed data may be stored with records that pertain to, for example, one or more of a team member's responsibilities, duties, strengths, interests, tasks, and combinations thereof. A person or electronic can cause actions to take effect for team members. For example, the x-button (x-encircle) may be used to remove a team-member person from an activity with or without consent of the person. Notification may, or may not be sent to the team member. And a response from the team member may or may not be required in order to update the schedule. A scheduling engine handles the updates to records and connectivity required to revise the reports and calendars, for example, that pertain to team members.

The action interface provides admin controls for a person or electronic that manages or has controls of team members' calendars. Commands allow the admin to, for example, request time or participation of a team member for a particular activity. The admin controls allow a person to enter data for the team's activities. The admin may also with a form or script, for example, schedule others time (calendar-icon), view alerts (exclamation-triangle-icon), set dates and times (righthand-arrow-encircle), check availability (righthand-arrow-encircle), scheduling conflict (righthand-arrow-encircle), view information (i-encircle), get information (i-encircle), or store information about an activity (i-encircle), and store an activity for revising later. One or more of the actions may be polymorphic and change display of action or command according to the following actions required to store or revise a record. For example, the Request button could display as Schedule or Confirm according to authentication, permissions preset, and/or permissions requested for the admin has for revising a team member's calendar. The tap action interface allows a person to for example traverse a display of schedules according to data records. For example, a schedule traverse may proceed for example by sorting data by city, ZIP code, date, time, team members, subject matter, activities, events, and combinations thereof.

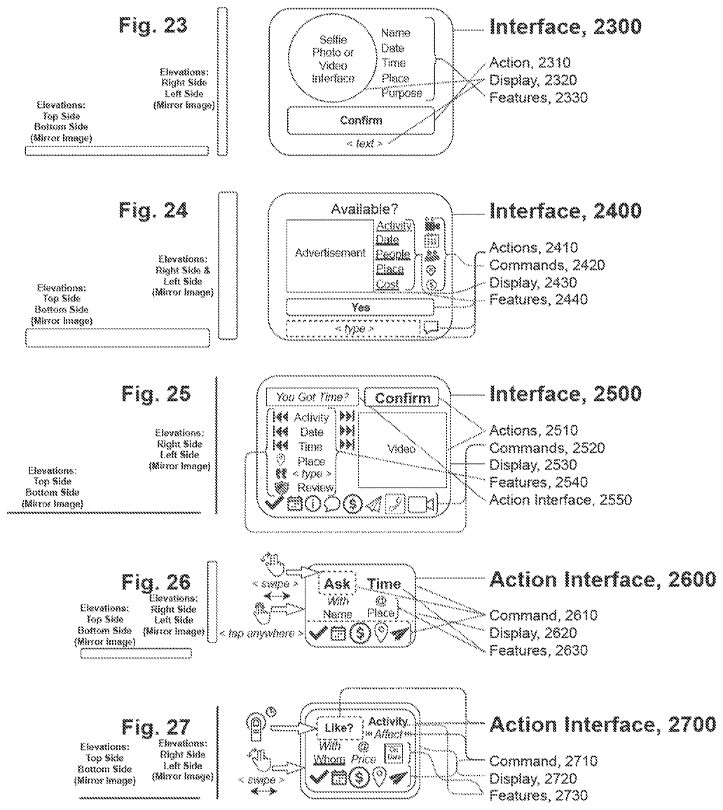

FIGS. 23-27 are interfaces and action interfaces that further comprise one or more functionalities as in FIGS. 1-22, portions thereof, layouts thereof, combinations thereof, and not limited thereby. These interfaces pertain for example to the recipient or receipt of actionable interfaces for producing events including confirming, inviting, and responding to requests for scheduling, booking, payment, and pricing. Elevations are shown for the interfaces, which may include the dimensions of a device, for an electronic interface, or both. The interface may be a smart card that allows a person to make purchases, store Apps, interact electronically through a wireless network, and may optionally comprise speakers, a telephone, camera, memory, ports, a touchscreen, and combinations thereof. These elevations as shown are examples, include actual dimensions as following, and furthermore apply to all Figures and embodiments herein.

FIG. 23. An interface that allows a person or electronic to confirm participation on a date and time, at a location, and for a purpose. The interface, 2300, includes actions, 2310, displays, 2320, and features, 2330, as shown. The interface may be, for example, a tile or popup window on a device, part of a software interface, or display as a notification on a device. The interface may display custom text for the recipient including for example a personalized message, a scheduling notification, and as response to the action presented on the display.

The selfie photo interface allows a person to take a photo and respond with the interface to include a photo of a person's response to the request. The video interface allows a person to record a video response with the interface to include a video response to the request. An affect engine may decipher the affect of the response and suggest a response to the sender. Approaches to decipher affect states are included in the reference section. The sender or the recipient may comprise scheduling or booking options according to an affective input of one or more image, audial, video, type, and combinations thereof. The interface is a visual card mail, vc-mail, or vcmail, and presents corresponding interfaces for one or more sender and one or more receiver in order to facilitate scheduling or booking according at least in part to one or more affects of the one or more receiver and sender. The interface may display on a device after being sent for example via electronic mail, through a sms text, a via connection, to an App, to an attribute address, and combinations thereof. The affect engine may interpret an image or video and ascribe one or more affective states to a sender or receiver. The affect engine may make offers or suggestions for one or more activity, schedule, day, time, location, or price according to one or more interpreted affects of a sender or receiver and combinations thereof.

FIG. 24. An interface that allows a person or electronic to confirm availability for an activity, on a date, with participating people who have confirmed, at a location, and for a cost. The interface, 2400, includes actions, 2410, displays, 2420, and features, 2430, as shown. Command representations may display that provide more information about an activity such as an advertisement or vignette video. Commands may display a link to activity specifics such as a record or event URL (in this case a film icon for a movie), a calendar, links to a schedule of participants or their profiles, a link to a GPS map marker, and a link to the price or the unique price for a person. The interface may be, for example, a tile or popup window on a device, part of a software interface, or display as a notification on a device. A person may compose a text response as a notification to another person, persons, a scheduling engine, booking engine, and confirmation electronics that are collecting confirmations from other persons for a particular activity, booking, or event. The text response may be posed to an electronic platform or profile.

FIG. 25. An interface allows a person or electronic to confirm availability or participation for an activity, with specific people, for a cost, at a place, with affective comments, and review data. The utility of the interface is, in addition to the convenience of presenting details to a person for quick response, allows display of information that pertains to rules and relations that are of interest to a person or preset in an electronic. The interface, 2500, includes actions, 2510, commands, 2520, displays, 2530, features, 2540, and action interface, 2550, as shown. The action interface may display text, as shown, such as an inquiry. The interface may be actionable by clicking in order to for a person to type a response. A person or electronic may select or specify data for the interface to send to a person or persons as an invite or advertisement.

An action of confirm causes a scheduling engine to schedule time in a calendar. The confirm action may also cause multiple actions including and not limited to notifying participants of an activity, notifying other persons such as a parent or guardian, revising a bookable calendar, placing a hold of time in a calendar, reserving a resource such as a room in a building or a table at a restaurant. Commands upon clicking or action by voice for example display data and records pertaining to a person's calendar. Commands representations display information about the activity, appointment, booking, calendar, or schedule. Commands also may include causing one or more connections with one or more participants or for example at a place of business as a restaurant. The commands also allow a person to scroll through activity options such as, for example, brunch, lunch, dinner, drinks, or dessert. Commands also allow a person to specify a different date or time. If a person updates the request, then the action may respond as an action interface with for example the text “Request” or “Invite.” A person may select the video box in order to select another venue. Information pertaining to the venue are then populated in the confirmation or invitation card interface. Then a recipient of the request may for example, confirm, update, reschedule, invite, cancel, decline, and so forth.

FIG. 26. An action interface may be an action interface and further comprise an action interface command. The interface, 2600, includes commands, 2610, displays, 2620, and features, 2630, as shown. An action interface command include a button, or polymorphic button, with the text “Ask.” The action interface in this case is utilized to ask a person to meet a sender whose name appears on the interface at a time and place. The sender can swipe left or right on the action interface button to select other actions or type. Actions may include for example invite, confirm, book, pay, reserve, and purchase. The interface may be utilized to communicate with a scheduling engine in order to effectuate a schedule, booking, or payment event.

Commands that include a conflict check, calendar schedule, price, location marker, and message interface. Once action or clicked these commands perform actions that pertain to a schedule or calendar. Commands representations may also present responsive interfaces such as for example pricing information, a GPS marker on a popup map, and a messaging interface. The portion of the action interface within the outer boundary, above the dashed-line, and outside of the action interface button is an action interface. The action interface may respond to a click, although the action may also have a rider that is triggered by a voice command, keystroke, and combinations thereof. A combination of click and rider may be used to compile a command at the click. Combinations of click and rider actions may produce variations on commands such as ask once but not twice, reply after dinner, or invite in the morning after breakfast at Tiffany's. A click is one example of an action, although riders may be combined in one or more combination with one or more commands. Riders can encode a private message, produce insider messages, change display features, and render the interface polymorphic according to receiver responses.

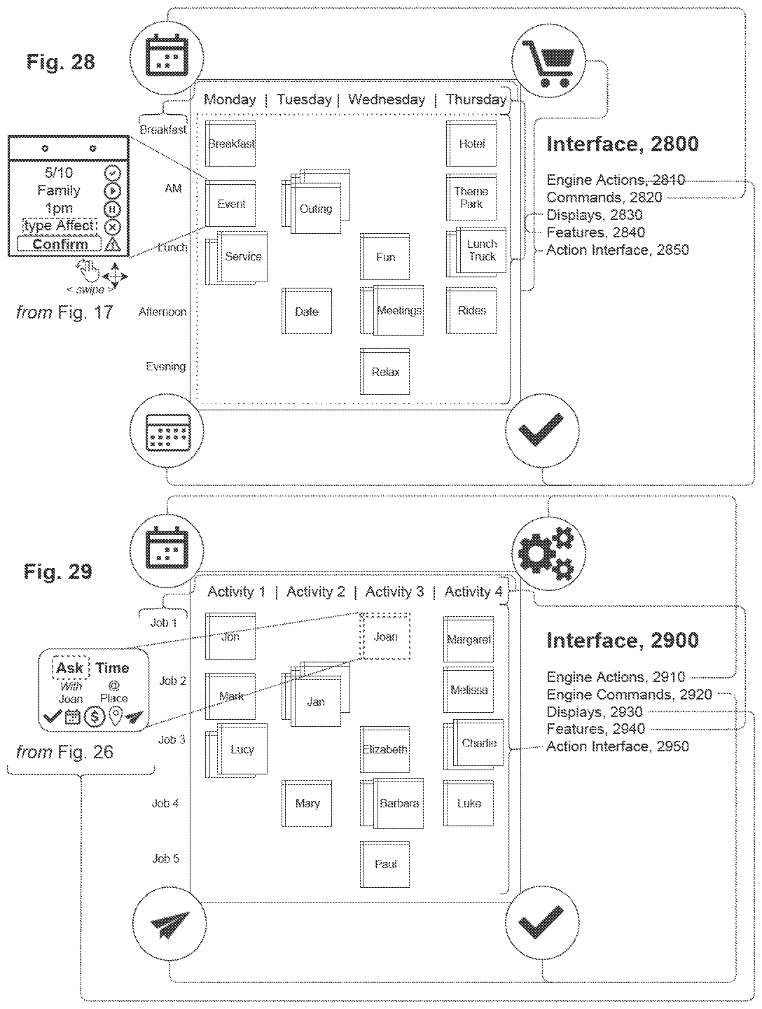

FIG. 27. An action interface comprises actionable commands and displays. A tap-and-hold may show a strength or indication of degree. Such as a tap may be held for one to five seconds to indicate how much a person likes something. An action interface or action area may be responsive in terms of color, type, visual, look, and feel in terms of representing affect. A tap for one second may represent a cool lukewarm tap-and-hold like while a tap and hold for five seconds may indicate a red-hot love. The display after a lukewarm like may be different or the same after a red-hot tap-and-hold love. The display may for example change from like to love with a sufficiently held tap-and-hold. The display may change color during the hold period to provide indicia that correspond with gradations of like from a bit of like to a lot of love. The action interface or the display may present different animated graphics or emojis that indicate strength of like, such as a sparkles, a heart, a volcano eruption, and fireworks. The action interface may further comprise a polymorphic action area that present additional commands after the user completes a customized tap-and-hold period according to an activity. The polymorphic button may then present a command for example such as “Book” in order to book an activity or “Post” in order to post the information to a social media profile.

FIGS. 28-29 organize the engines into a visual interface the foregoing interactivity. One or more of the foregoing interfaces and/or action interfaces may be for example, sent, received, responded, invited, confirmed, registered, retrieved, triggered, scheduled, and booked through the visual interfaces. Any specific or envisioned embodiments may be rendered as an action or interface through the visual display interface. The visual display interface as shown includes actions 2810|2910, commands 2820|2920, displays 2830|2930, features, 2840|2940, and action interfaces 2850|2950. The visual interfaces represent schedules for scheduling (FIG. 28) and schedules for bookings (FIG. 29). Schedules may pertain for example to one or more of and not limited to schedules for activities, affects, appointments, bookings, resources, tables, payments, prices, people, events, accounts, itineraries, manufacturing, hospitality, recreation, travel, and to any schedulable time or schedule. As such, a schedule engine may comprise one or more additional engines that pertain to the type of schedule that the engine is scheduling.

In FIG. 28, action items displayed as tiles are arranged that correspond with days of the week, times of day, and daytime activities. A person or electronic may move or cause to move tiles into time slots. The tiles may represent visual differences among displays including audiovisual displays according to one or more affects associated with one or more activities, reviews, review history, log record, personalities, affective aims for the time, experiences with people, and combinations thereof, for example. Colors, symbols, icons, shapes, sizes, morphology, presentation order, and representations may be used to display information pertaining to a record in the visual action item. The action item tiles are responsive to any command to cause effects on the records for any action including for example one or more of and not limited to display, schedule, check, pay, confirm, and combinations thereof. Display of action interfaces may include any one or more of the foregoing from FIGS. 1-27. Actions may be utilized accordingly to effectuate scheduling for one or more of the aforementioned schedules.

A person or electronic may move tiles into columns as a person schedules events for their self, for other persons, and combinations thereof. Engine Actions are shown at the four corners of the interface that correspond with at the top left and clockwise right, a schedule engine, a purchase engine, a booking engine, and a payment engine. The schedule engine may synchronize calendars, the purchase engine may purchase tickets, a booking engine may book activities, and a payment engine may provide payments for the purchases and bookings.

One or more of the engines may be actionable according to one or more rules satisfying a condition for action. For example, a proposed itinerary having resolved schedules among five participating adults and children would then be schedulable and bookable. One or more rules and relations may be configured with one or more Engines Actions according to the types of features that are known to the types of schedules including one or more activities, affects, appointments, bookings, resources, tables, payments, prices, people, events, accounts, itineraries, manufacturing, hospitality, recreation, and travel. One or more schedules may appear on the interface according to actions such as swipes or tapes in order to change days, weeks, dates, times, places, people, and schedulable features for the types of schedules.

FIG. 29, action items displayed as tiles are arranged that correspond with activities, jobs, and people. In addition to the specifications described in FIGS. 1-28, Engine Actions include for example a calendar engine (top left) and a schedule engine (top right). The schedule engine may be used to transmit information to the persons named in the tiles whose profiles are linked with engine. Clicking the schedule engine action would for example send interfaces to schedule engines linked with each of the persons in the tiles. The engine would, according to settings in the profile, for example, process requests for participation from participants and check calendars for one or more of and not limited to scheduling conflicts, limitations of time, travel time between locations, travel options, costs of travel options, availability of travel, and combinations thereof. Engine Commands are examples of commands that are provided by the engine. Any of the foregoing commands may be produced by an engine in order to provide communication, connectivity, or transmissions between one or more engines associated with one or more accounts or profiles of one or more persons or electronics. Action interfaces, interfaces, commands, displays, and engines may be linked or associated with one or more of and not limited to an account, profile, electronic, device, person, and combinations thereof.

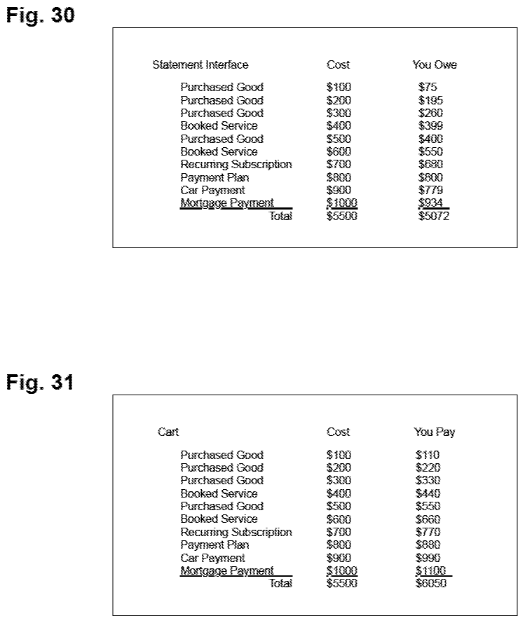

FIG. 30, an interface showing the output of a pricing engine that produces prices uniquely for a person. The pricing engine may be linked to one or more of a payment engine, a scheduling engine, a booking engine, a purchase engine, and combinations thereof.

FIG. 31, an interface showing the output of a pricing engine that produces prices uniquely for a person. The pricing engine may be linked to one or more of a payment engine, a scheduling engine, a booking engine, a purchase engine, and combinations thereof.

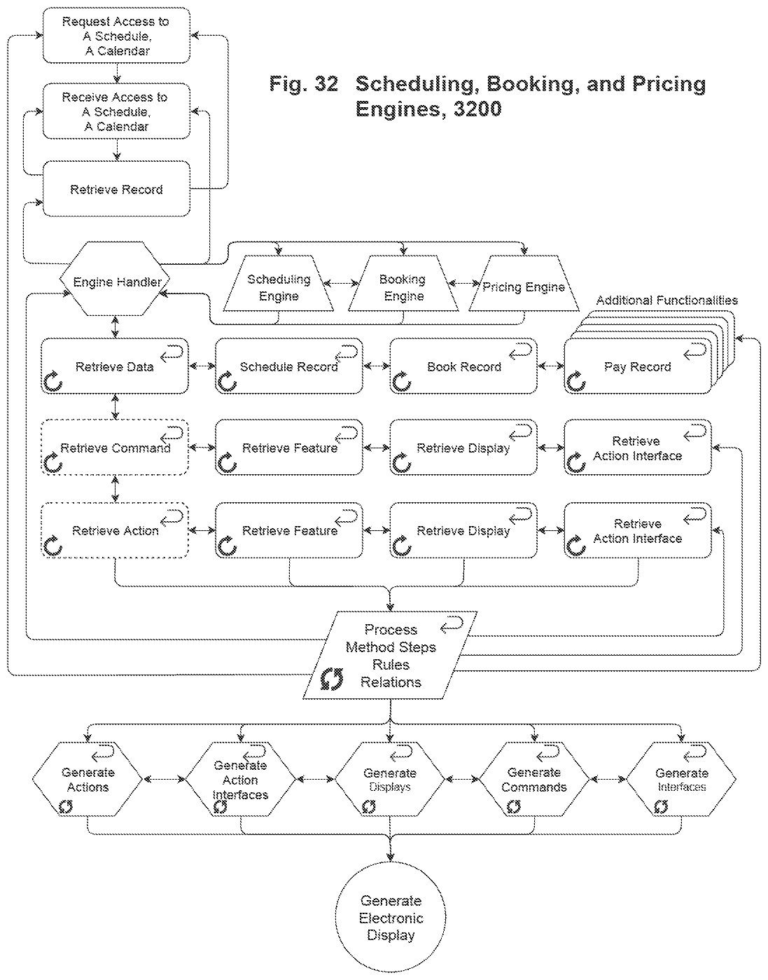

FIG. 32, a diagram of process flow for exemplary engines. Linear arrows indicate one or more requests, retrievals, receivals, transmission, calls, and combinations thereof. Arrow directions show the direction of communications. Circular single-arrow shows that the step may be repeated. Elliptical single-arrow shows a step may return for example a value or feature. Circular double-arrow shows that the process may be for example dynamic, interactive, rendered, or ongoing. Processes and method steps may retrieve and supply rules and relations that are needed for example to generate one or more actions, action interfaces, displays, commands, features, and interfaces, and combinations thereof. An engine handler may handle methods between one or more engines for one or more persons, electronics, profiles, communication, connections, transmissions, traversals, and combinations thereof.

FIGS. 1-32 furthermore comprise example of rules and relations as explicated in their descriptions. And, in addition to descriptions herein, the specification furthermore encompass features of scheduling, booking, calendars, communications transmissions, payments, electronic payments, searching, social networking, social media, and combinations thereof as being incorporated by reference and as examples of further definitions of applicable subject matter. A scheduling engine may pertain, for example, to any of the foregoing. A booking engine may pertain, for example, to any of the foregoing. A payment engine may pertain, for example, to any of the foregoing. My engines may utilize any means of communication, transmission, or display to one or more of an engine handler, other engines, API, SDK, device, electronic, person, and combinations thereof. Actions, action interfaces, buttons, commands, displays, engines, features, interfaces, and combinations thereof are described herein may perform any of a call, implement, encode, program, compile, instantiate, script, batch, run, execute, store, and combinations thereof from the disclosures that are incorporated by reference. Actions, action interfaces, buttons, commands, displays, engines, features, and interfaces from one or more of the aforementioned may be combined without limitation of any of the foregoing and fully within the scope of the preferred embodiments as defined and described herein. Further, said disclosures are incorporated by reference herein for the sake of conciseness and by being incorporated by reference are intended not in any to narrow or limit the scope of actions, action interfaces, buttons, commands, displays, engines, features, interfaces, and combinations.

### REFERENCES, CITATIONS, AND DEFINITIONS

The following citations are each Incorporated Herein by Reference each in their entirety:
Peter Brucker, Scheduling Algorithms. Springer 2010, incorporated herein by reference in entirety.
Michael Pinedo, Scheduling: Theory, Algorithms, and Systems. Springer 2016, incorporated herein by reference in entirety.
Jose Framinan, et al. Manufacturing Scheduling Systems. Springer 2014, incorporated herein by reference in entirety.
Joseph Leung. Handbook of Scheduling. CRC Press 2004, incorporated herein by reference in entirety.
Owen Astrachan. A Computer Science Tapestry, https://www2.cs.duke.edu/csed/tapestry/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties.
Max Scheler. Formalism in Ethics and Non-Formal Ethics of Values, 1973, Manfred S. Frings and Roger L. Funk (trs.), Evanston, Ill.: Northwestern University Press, incorporated herein by reference in entirety.

Max Scheler. “An a priori Hierarchy of Value-Modalities,” in Readings in Existential Phenomenology: Daniel O'Connor (tr.), Nathaniel Lawrence and Daniel O'Connor (eds.). Englewood, N.J.: Prentice Hall, 1967, incorporated herein by reference in entirety.
Max Scheler. “Toward a Stratification of the Emotional Life,” in Readings in Existential Phenomenology, Daniel O'Connor (tr.), Nathaniel Lawrence and Daniel O'Connor (eds.). Englewood, N.J.: Prentice Hall, 1967, incorporated herein by reference in entirety.
Charles Darwin, The Expression of the Emotions in Man and Animals, New York: Oxford University Press, 2009, incorporated herein by reference in entirety.
Angela Ackerman and Becca Puglisi, The Emotion Thesaurus, ePub, 2012, 2018. emojis, https://unicode.org/emoji/charts/full-emoji-list.html, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties.
Tvede, Lars, et al. “Data Broadcasting.” Wiley, 2001, incorporated herein by reference in entirety.
Kappen, Bert, et al. Neural Networks. World Scientific Publishing, 1998, incorporated herein by reference in entirety.
Jiang, Hai. Dynamic airline scheduling and robust airline schedule de-peaking, MIT 2007, incorporated herein by reference in entirety.
Theis, Georg. Incorporating attitudes in airline itinerary choice, MIT 2011, incorporated herein by reference in entirety.
Adobe Systems Incorporated: Photoshop, Illustrator, InDesign, XD, Premiere Pro, After Effects, Dimension, Lightroom, Spark, Behance, Dreamweaver, Animator, Character Animator, Audition, Prelude, and Fuse, https://helpx.adobe.com/support.html, https://www.adobe.io/apis.html, are incorporated by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of displays, representations, interfaces, actions, commands, and visual.
Apple Information Technology Company, https://developer.apple.com/documentation/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of displays, representations, interfaces, actions, commands, visual, and audible features.
Booking dotcom Travel Company, https://developers.booking.com/api/index.html, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of displays, representations, searching, booking, profiles, interfaces, actions, commands, visual, and audible features.
Google AdWords, https://developers.google.com/adwords/api/docs/guides/start/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of advertisements, an advertising network, representations, displays, searching, payments, interfaces, bookable interfaces, searchable interfaces, payable interfaces, actions, booking, commands, & audiovisuals.
Google Calendar, https://developers.google.com/calendar, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of appointments, bookings, calendars, payments, representations, displays, searching, booking, profiles, interfaces, actions, commands, and audiovisuals.
iCal Computer File Format, https://icalendar.org/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of appointments, bookings, calendars, payments, representations, displays, searching, booking, profiles, interfaces, actions, commands, and audiovisuals.
Expedia Travel Company, https://hackathon.expedia.com/docs/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of advertisements, representations, displays, searching, booking, payments, interfaces, actions, commands, and audiovisuals.
Facebook Social Networking Company, https://developers.facebook.com/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of advertisements, representations, displays, profiles, searching, booking, payments, interfaces, actions, commands, social networking, social media, alerts, notifications, scheduling, and audiovisuals.
FareHarbor Booking Company, https://fareharbor.com/help/integrations/api-connectivity/external-integration-api/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of representations, displays, searching, scheduling, booking, payments, profiles, interfaces, actions, commands, and audiovisuals.
Instagram Social Networking Service, https://www.instagram.com/developer/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of advertisements, representations, displays, profiles, searching, booking, payments, interfaces, actions, commands, social networking, social media, alerts, notifications, scheduling, and audiovisuals.
LinkedIn Professional Services, https://developer.linkedin.com/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of advertisements, representations, displays, profiles, searching, booking, payments, interfaces, actions, commands, social networking, social media, alerts, notifications, scheduling, and audiovisuals.
Oculus Virtual Reality Company, https://developer.oculus.com/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of advertisements, representations, displays, profiles, searching, booking, payments, interfaces, actions, commands, social networking, social media, alerts, notifications, scheduling, and audiovisuals.
PayPal Online Payments Company, https://developer.paypal.com/docs/api/overview/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of advertisements, representations, displays, profiles, searching, booking, payments, interfaces, actions, commands, alerts, notifications, scheduling, and audiovisuals.
Reddit Social News Company, https://www.reddit.com/dev/api/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of advertisements, representations, displays, profiles, searching, booking, payments, interfaces, actions, commands, social networking, social media, alerts, notifications, scheduling, and audiovisuals.
Stripe Banking Company, https://stripe.com/docs/api/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of representations, displays, profiles, searching, payments, interfaces, actions, commands, alerts, notifications, scheduling, and audiovisuals.
Trip Advisor Travel and Restaurant Corn pang, https://developer-tripadvisor.com/content-api/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of advertisements, representations, displays, profiles, searching, booking, payments, interfaces, actions, commands, social networking, social media, alerts, notifications, scheduling, and audiovisuals.
Twilio Cloud Communications Platform, https://www.twilio.com/docs/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of communications, representations, displays, connections, profiles, searching, booking, payments, interfaces, actions, commands, social networking, social media, alerts, notifications, scheduling, and audiovisuals.
Twitter Social Networking Company, https://developer.twitter.com/en/docs.html, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of representations, displays, connections, profiles, searching, booking, payments, interfaces, actions, commands, social networking, social media, alerts, notifications, scheduling, and audiovisuals.
Uber Ridesharing Company, https://developer.uber.com/docs/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entireties. Definitions of communications, representations, destinations, displays, connections, profiles, searching, booking, payments, interfaces, actions, commands, social networking, social media, alerts, notifications, scheduling, and audiovisuals.
WhatsApp Mobile Application, https://www.whatsapp.com/business/api/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of communications, representations, displays, connections, profiles, searching, booking, payments, interfaces, actions, commands, social networking, social media, alerts, notifications, scheduling, and audiovisuals.
YouTube Video Sharing Company, https://developers.google.com/youtube/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of advertisements, communications, representations, displays, connections, profiles, searching, booking, payments, interfaces, actions, commands, social networking, social media, alerts, notifications, scheduling, and audiovisuals.
ZenDesk Customer Service Software Company, https://developer.zendesk.com/rest_api/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of communications, representations, displays, connections, profiles, searching, booking, payments, interfaces, actions, commands, social networking, social media, alerts, notifications, scheduling, and audiovisuals.
Display, Device, Action Interface, and Interface Sizes, are for example: http://screensiz.es, https://www.rtings.com/tv/reviews/by-size/size-to-distance-relationship, and https://en.wikipedia.org/wiki/Display_size, each of which are incorporated by reference in its entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties. Definitions of communications, representations, displays, connections, interfaces, actions, commands, and audiovisuals.
HTML. HTML-CSS, and Style Sheets, https://www.w3schools.com/, https://www.w3schools.com/html/, https://www.w3schools.com/css/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties.
XML https://www.w3schools.com/xml/, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties.
JavaScript mozᵢ∥a https://www.w3schools.com/js/ and https://developer.mozilla.org/en-US/docs/WebiJavaScript/Reference, incorporated herein by reference in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties.
References cited in this and cross-reference application are each incorporated herein by reference each in entirety. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties.

### ADDITIONAL PREFERRED EMBODIMENTS

For all figures, embodiments, and depictions, the following applies to each and every such figure, embodiment, description, depiction, and semantic representation, in whole, in part, portions thereof, and and combinations thereof without exception and without limitation:

Any visual representation for one or more action interfaces may be selected and are not limiting to the utility. The rules and relations that define the functionality of the action interfaces may be defined by as scheduling or booking engines according to the data stored in a record, for example, for one or more of and not limited to a person, participant, activity, affect, location, calendar, time, cost, and combinations thereof. The responsiveness of the action interface may furthermore be defined by a scheduling, booking, or payment engine according to commands that are associated with interactions with and records about a schedule, booking, or payment.

The aforementioned are described as illustrative and not intended to limit utility in any manner. Additional and/or other representations may be utilized while being well within the bounds of the embodiments described and depicted. The aforementioned may function individually, in part, whole, and in combinations thereof.

Data that is need for the connection or that is transmitted may be defined by rules and relations in the scheduling engine or booking engine. Data as such may be stored through one or more of the interfaces, profiles of people, storage, memory, any records, and combinations thereof. Actions pertaining thereto may update, modify, revise, and act upon one or more record with actions described herein including and not limited to for example accept, schedule and add.

Examples of visual action interfaces are applicable to each and every embodiment as illustrated and envisioned in this disclosure. The representation of action interfaces accords with rules and relations about scheduling and booking engines for one or more industries that utilize calendars, schedules, and/or payments in their business methods and commercial transactions.

Figures represent depictions of preferred embodiments and are not limited to designations of preferred embodiments. Figures may also provide semantic representations that are explicitly intended to provide narrative descriptions that are well within the bounds of the embodiments described and claimed herein. Copyright 2018, Applicant reserves all rights to the entire contents of the Specification, Figures, and Interfaces. My reproductions or publications of any text or figures without previous written consent of the Applicant is expressly prohibited.

Narrative descriptions may interpret semantic representations of Figures in order to provide specific variations of embodiments of scheduling engines and booking engines. Descriptions of semantic representations of features appear, for example, in definitions, Figure descriptions, in the instant specification, in referenced specifications, incorporated references, references referenced that are furthermore herein incorporated, and the references that are incorporate by reference so as to all be incorporated in their entirety therein and herewith. As such, narrative descriptions of semantic representations are encompassed in the envisioned, embodied, discussed, claimed, and claimable inventions. Narrative descriptions and semantic representations are explicitly envisioned as providing disclosures and enabling descriptions of envisioned and additional preferred embodiments with one or more of figures, definitions, descriptions, claims, representations, references, and incorporations by reference.

### PREFERRED DESIGN EMBODIMENTS

Elevations are shown for the interfaces in FIGS. 23-27 are illustrative of elevations that may pertain to each and every illustrated embodiment in FIGS. 1-32. The dimensions are for example a device, a screen, a display, an electronic interface, and combinations thereof. Furthermore, additional dimensions may be selected from any dimension provided in the definitions sections in inch or centimeter. Each and every interface and action interface may comprise a device, screen, or displayed interface. Each and every interface and action interface as a dimension of width and length selected independently or in combination from any dimension provided in the Definitions Section in inch or centimeter. Each and every interface and action interface as a dimension of thickness selected independently, or in combination with width and length, from any dimension provided in the Definitions Section in inch or centimeter.

The elevations depicted in FIGS. 23-27 are representative of certain variations of length, width, and thickness that may be reflective any dimension selected from the definitions section, specifically those for dimensions of device, display, screen, or electronic interface. The interfaces may be a smart card that allows a person to make purchases, store Apps, interact electronically through a wireless network, and may optionally comprise speakers, a telephone, camera, memory, ports, a touchscreen, and combinations thereof. These elevations as shown and those selected are preferred embodiments with respect to selected length, width, and thickness, and furthermore apply to all Figures, elevations, and embodiments encompassed and described herein.

It is important to note that FIGS. 1-32 illustrate specific applications and embodiments of the invention, and are not intended to limit the scope of the present disclosure or claims to that which is presented therein. For example, the Figures show methods of producing interfaces with one or more scheduling, booking, and pricing engines. Upon reading the specification and reviewing the drawings hereof, it will become immediately obvious to those skilled in the art that myriad other embodiments of the invention are possible, and that such embodiments are contemplated and fall within the scope of the presently claimed invention. The elements of the action interfaces, interfaces, schedules, and engines described in association with FIGS. 2-32 can be combined as desired for a particular application.

When introducing elements of the examples disclosed herein, the articles “a,” “an,” “the” and “said” are intended to mean that there are one or more of the elements. The terms “comprising,” “including and “having” are intended to be open-ended and mean that there may be additional elements other than the listed elements. It will be recognized by the person of ordinary skill in the art, given the benefit of this disclosure, that various components of the examples can be interchanged or substituted with various components in other examples. While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of preparing a schedule, comprising:
Setting an origin;
Setting one or more destinations;
Setting an optional intermediate or final destination;
Setting a duration of time at one or more of said destinations;
Setting one or more availabilities;
Setting one or more optional rules;
Requesting relation data pertaining to distance to travel between destinations;
Requesting relation data pertaining to time to travel between destinations;
Receiving data regarding distance to travel;
Receiving data regarding time to travel;
Selecting one or more sequences of destinations;
Requesting data pertaining to relations of a portion of a sequence;
Requesting data pertaining to confirmation of a portion or whole of a sequence;
Sequencing a listing of destinations;
Storing and displaying a sequence of destinations;
Optionally sending an alert regarding an arrival at a destination; and
Optionally requesting an update of said schedule after arriving at a destination.

2. A method of providing a booking interface, comprising
Receiving calendar availability comprising dates and times,
Receiving selections of one or more activities;
Receiving selections of one or more affects;
Receiving selections of a budget;
Traversing a schedule or results list of activities;
Determining one or more activities with compatible affects, availability, and budget;
Determining potential bookable availability by date and time;
Preparing a bookable interface comprising activity, date, time, affect, and budget.

3. A method of providing a booking, comprising
A person inputting into memory one or more of an activity name and description;
Said person inputting affects about said activity from customers who participate in said activity;
Said person inputting availability and price per booking for said activity;
Receiving a request from another person for a booking comprising rules, wherein said rules comprises at least one affect, geographic area, date, and time;
Determining one or more booking options;
Responding with a booking interface for an activity;
Receiving a selection for a booking; and
Processing a payment for a booking.

4.-40. (canceled)
